(19) United States
(12) Patent Application Publication
(10) Pub. No.: US 2014/0237156 A1
(43) Pub. Date: Aug. 21, 2014

(54) MULTI-PATH ID ROUTING IN A PCIE EXPRESS FABRIC ENVIRONMENT

(71) Applicant: PLX Technology, Inc., Sunnyvale, CA (US)

(72) Inventors: Jack REGULA, Durham, NC (US); Jeffrey M. DODSON, Portland, OR (US); Nagarajan SUBRAMANIYAN, San Jose, CA (US)

(73) Assignee: PLX Technology, Inc., Sunnyvale, CA (US)

(21) Appl. No.: 14/231,079

(22) Filed: Mar. 31, 2014

Related U.S. Application Data
(63) Continuation-in-part of application No. 13/660,791, filed on Oct. 25, 2012.

(51) Int. Cl. G06F 13/40

(52) U.S. Cl. CPC G06F 13/4027
USPC 710/314

(57) ABSTRACT

PCIe is a point-to-point protocol. A PCIe switch fabric has multi-path routing supported by adding an ID routing prefix to a packet entering the switch fabric. The routing is converted within the switch fabric from address routing to ID routing, where the ID is within a Global Space of the switch fabric. Rules are provided to select optimum routes for packets within the switch fabric, including rules for ordered traffic, unordered traffic, and for utilizing congestion feedback. In one implementation a destination lookup table is used to define the ID routing prefix for an incoming packet. The ID routing prefix may be removed at a destination host port of the switch fabric.

### CROSS REFERENCE TO RELATED APPLICATIONS

The present application is a continuation-in-part of U.S. patent application Ser. No. 13/660,791, filed on Oct. 25, 2012, entitled, “METHOD AND APPARATUS FOR SECURING AND SEGREGATING HOST TO HOST MESSAGING ON PCIe FABRIC.”

This application incorporates by reference, in their entirety and for all purposes herein, the following U.S. patent and application Ser. No. 13/624,781, filed Sep. 21, 2012, entitled, “PCI EXPRESS SWITCH WITH LOGICAL DEVICE CAPABILITY”; Ser. No. 13/212,700 (now U.S. Pat. No. 8,645,605), filed Aug. 18, 2011, entitled, “SHARING MULTIPLE VIRTUAL FUNCTIONS TO A HOST USING A PSEUDO PHYSICAL FUNCTION”; and Ser. No. 12/979,904 (now U.S. Pat. No. 8,521,941), filed Dec. 28, 2010, entitled “MULTI-ROOT SHARING OF SINGLE-ROOT INPUT/OUTPUT VIRTUALIZATION.”

This application incorporates by reference, in its entirety and for all purposes herein, the following U.S. Pat. No. 8,553,683, entitled “THREE DIMENSIONAL FAT TREE NETWORKS.”

### FIELD OF THE INVENTION

The present invention is generally related to routing packets in a switch fabric, such as PCIe based switch fabric.

### BACKGROUND OF THE INVENTION

Peripheral Component Interconnect Express (commonly described as PCI Express or PCIe) provides a compelling foundation for a high performance, low latency converged fabric. It has near-universal connectivity with silicon building blocks, and offers a system cost and power envelope that other fabric choices cannot achieve. PCIe has been extended by PLX Technology, Inc. to serve as a scalable converged rack level “ExpressFabric.”

However, the PCIe standard provides no means to handle routing over multiple paths, or for handling congestion while doing so. That is, conventional PCIe supports only tree structured fabric. There are no known solutions in the prior art that extend PCIe to multiple paths. Additionally, in a PCIe environment, there is also shared input/output (I/O) and host-to-host messaging which should be supported.

Therefore, what is desired is an apparatus, system, and method to extend the capabilities of PCIe in an ExpressFabric™ environment to provide support for topology independent multi-path routing with support for features such as shared I/O and host- to-host messaging.

### SUMMARY OF THE INVENTION

An apparatus, system, method, and computer program product is described for routing traffic in switch fabric that has multiple routing paths. Some packets entering the switch fabric have a point-to-point protocol, such as PCIe. An ID routing prefix is added to those packets upon entering the switch fabric to convert the routing from conventional address routing to ID routing, where the ID is with respect to a global space of the switch fabric. A lookup table may be used to define the ID routing prefix. The ID routing prefix may be removed from a packet leaving the switch fabric. Rules are provided to support selecting a routing path for a packet when there is ordered traffic, unordered traffic, and congestion.

### BRIEF DESCRIPTION OF THE DRAWINGS

FIG. 1 is a block diagram of switch fabric architecture in accordance with an embodiment of the present invention.

FIG. 2 illustrates simulated throughput versus total message payload size in a Network Interface Card (NIC) mode for an embodiment of the present invention.

FIG. 3 illustrates the MCPU (Management Central Processing Unit) view of the switch in accordance with an embodiment of the present invention.

FIG. 4 illustrates a host port's view of the switch/fabric in accordance with an embodiment of the present invention.

FIG. 5 illustrates an exemplary ExpressFabric™ Routing prefix in accordance with an embodiment of the present invention.

FIG. 6 illustrates the use of a ternary CAM (T-CAM) to implement address traps.

FIG. 7 illustrates an implementation of ID trap definition.

FIG. 8 illustrates DLUT route lookup in accordance with an embodiment of the present invention.

FIG. 9 illustrates a BECN packet format.

FIG. 9B illustrates a 3-stage Fat tree.

FIG. 10 illustrates an embodiment of Vendor Specific DLLP for WR Credit Update.

### DETAILED DESCRIPTION

The present application is a continuation-in-part of U.S. patent application Ser. No. 13/660,791. U.S. patent application Ser. No. 13/660,791 describes a PCIe fabric includes at least one PCIe switch. The switch fabric may be used to connect multiple hosts. The PCIe switch implements a fabric-wide Global ID, GID, that is used for routing between and among hosts and endpoints connected to edge ports of the fabric or embedded within it and means to convert between conventional PCIe address based routing used at the edge ports of the fabric and Global ID based routing used within it. GID based routing is the basis for additional functions not found in standard PCIe switches such as support for host to host communications using ID-routed VDMs, support for multi-host shared I/O, support for routing over multiple/redundant paths, and improved security and scalability of host to host communications compared to non-transparent bridging.

A commercial embodiment of the switch fabric described in U.S. patent application Ser. No. 13/660,791 (and the other patent applications and patents incorporated by reference) was developed by PLX Technology, Inc. and is known as ExpressFabric™ ExpressFabric™ provides three separate host-to-host communication mechanisms that can be used alone or in combination. An exemplary switch architecture developed by PLX, Technology, Inc. to support ExpressFabric™ is the Capella 2 switch architecture, aspects of which are also described in the patent applications and patents incorporated by reference. The Tunneled Windows Connection mechanism allows hosts to expose windows into their memories for access by other hosts and then allows ID routing of load/store requests to implement transfers within these windows, all within a connection oriented transfer model with security. Direct Memory Access (DMA) engines integrated into the switches support both a NIC mode for Ethernet tunneling and a Remote Direct Memory Access (RDMA) mode for direct, zero copy transfer from source application buffer to destination application buffer using as an example, RDMA stack and interfaces, such as the OpenFabrics Enterprise Distribution (OFED) stack. ExpressFabric™ host-to-host messaging uses ID-routed PCIe Vendor Defined Messages together with routing mechanisms that allow non-blocking fat tree (and diverse other topology) fabrics to be created that contain multiple PCIe bus number spaces.

The DMA messaging engines built into ExpressFabric™ switches expose multiple DMA virtual functions (VFs) in each switch for use by virtual machines (VMs) running on servers connected to the switch. Each DMA VF emulates an RDMA Network Interface Card (NIC) embedded in the switch. These NICs are the basis for the cost and power savings advantages of using the fabric: servers can be directly connected to the fabric; no NICs or Host Bus Adapters (HBAs) are required. The embedded NICs eliminate the latency and power consumption of external NICs and Host Channel Adapters (HCAs) and have numerous latency and performance optimizations. The host-to-host protocol includes end-to-end transfer acknowledgment to implement a reliable fabric with both congestion avoidance properties and congestion feedback.

ExpressFabric™ also supports sharing Single Root, Input Output Virtual (SR-IOV) or multifunction endpoints across multiple hosts. This option is useful for allowing the sharing of an expensive Solid State Device (SSD) controller by multiple servers and for extending communications reach beyond the ExpressFabric™ boundaries using shared Ethernet NICs or converged network adapters. Using a management processor, the Virtual Functions (VFs) of multiple SR-IOV endpoints can be shared among multiple servers without need for any server or driver software modifications. Single function endpoints connected to the fabric may be assigned to a single server using the same mechanisms.

Multiple options exist for fabric, control plane, and Management Central Processing Unit (MCPU) redundancy and fail over.

ExpressFabric™ can also be used to implement a Graphics Processing Unit (GPU) fabric, with the GPUs able to load/store to each other directly, and to harness the switch's RDMA engines.

The ExpressFabric™ solution offered by PLX integrates both hardware and software. It includes the chip, driver software for host-to-host communications using the NICs embedded in the switch, and management software to configure and manage both the fabric and shared endpoints attached to the fabric.

One aspect of embodiments of the present invention is that unlike standard point-to-point PCIe, multi-path routing is supported in the switch fabric to handle ordered and unordered routing, as well as load balancing. Embodiments of the present invention include a route table that identifies multiple paths to each destination ID together with the means for choosing among the different paths that tend to balance the loads across them, preserve producer/consumer ordering, and/or steer the subset of traffic that is free of ordering constraints onto relatively uncongested paths.

### 1.1 System Architecture Overview

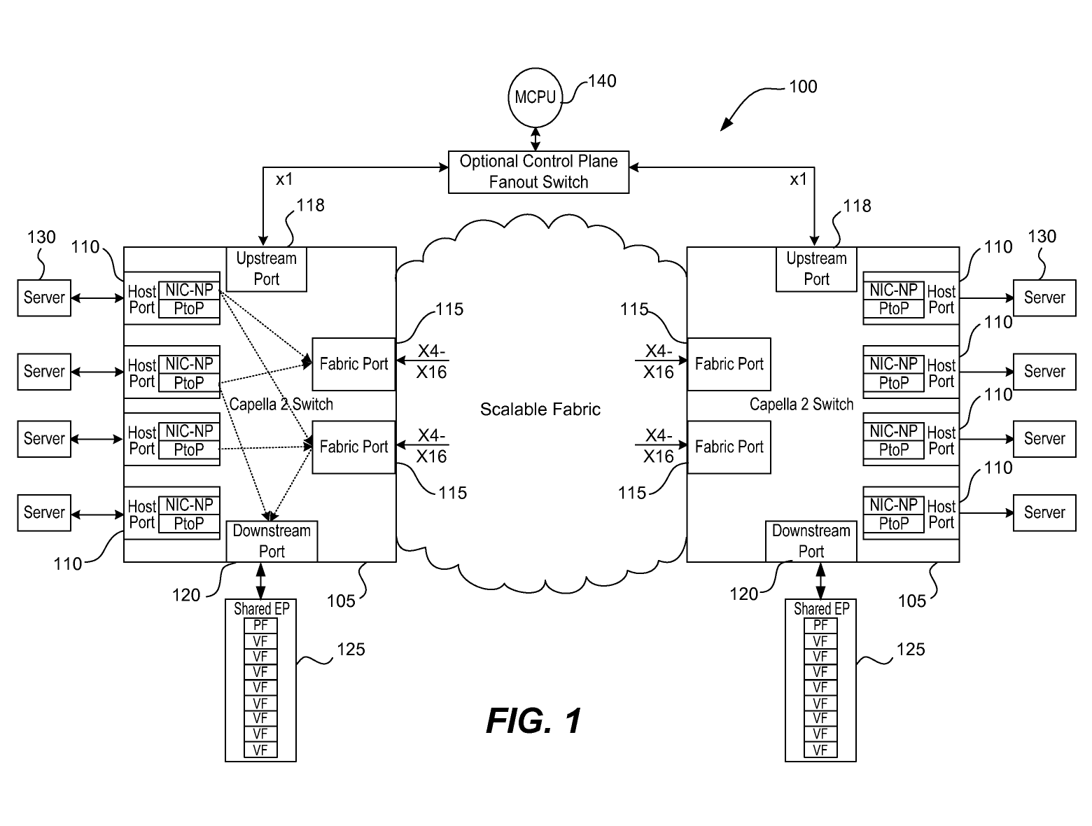

Embodiments of the present invention are now discussed in the context of switch fabric implementation. FIG. 1 is a diagram of a switch fabric system 100. Some of the main system concepts of ExpressFabric™ are illustrated in FIG. 1, with reference to a PLX switch architecture known as Capella 2.

Each switch 105 may include host ports 110, fabric ports 115, an upstream port 118, and downstream port(s) 120. The individual host ports 110 may include a Network Interface Card (NIC) and a virtual PCIe to PCIe bridge element below which I/O endpoint devices are exposed to software running on the host. In this example, a shared endpoint 125 is coupled to the downstream port and includes physical functions (PFs) and Virtual Functions (VFs). Individual servers 130 may be coupled to individual host ports. The fabric is scalable in that additional switches can be coupled together via the fabric ports. While two switches are illustrated, it will be understood that an arbitrary number may be coupled together as part of the switch fabric, symbolized by the cloud in FIG. 1. While a Capella 2 switch is illustrated, it will be understood that embodiments of the present invention are not limited to the Capella 2 switch architecture.

A Management Central Processor Unit (MCPU) 140 is responsible for fabric and I/O management and must include an associated memory having management software (not shown). In one optional embodiment, a semiconductor chip implementation uses a separate control plane 150 and provides an x1 port for this use. Multiple options exist for fabric, control plane, and MCPU redundancy and fail over. The Capella 2 switch supports arbitrary fabric topologies with redundant paths and can implement strictly non-blocking fat tree fabrics that scale from 72x4 ports with nine switch chips to literally thousands of ports.

In one embodiment, inter-processor communications are supported by RDMA-NIC emulating DMA controllers at every host port and by a Tunneled Window Connection (TWC) mechanism that implements a connection oriented model for ID-routed PIO access among hosts to that replace the non-transparent bridges of previous generation PCIe switches that route by address.

A Global Space in the switch fabric is defined. The hosts communicate by exchanging ID routed Vendor Defined Messages in a Global Space bounded by the TWCs after configuration by MCPU software.

The Capella 2 switch supports the multi-root (MR) sharing of SR-IOV endpoints using vendor provided Physical Function (PF) and Virtual Function (VF) drivers. In one embodiment, this is achieved by a CSR redirection mechanism that allows the MCPU to intervene and snoop on Configuration Space transfers and, in the process, configure the ID-routed tunnels between hosts and their assigned endpoints, so that the host enjoys a transparent connection to the endpoints.

In one embodiment, the fabric ports 115 are PCIe downstream switch ports enhanced with fabric routing, load balancing, and congestion avoidance mechanisms that allow full advantage to be taken of redundant paths through the fabric and thus allow high performance multi-stage fabrics to be created.

In one embodiment, a unique feature of fabric ports is that their control registers don't appear in PCIe Configuration Space. This renders them invisible to BIOS and OS boot mechanisms that understand neither redundant paths nor congestion issues and frees the management software to configure and manage the fabric.

### 1.2. Tunneled Window Connections

In prior generations of PCIe switches and on PCI busses before that, multiple hosts were supported via Non-Transparent Bridges (NTBs) that provided isolation and translation between the address spaces on either side of the bridge. The NTBs performed address and requester ID translations to enable the hosts to read and write each other's memories. In ExpressFabric™, non-transparent bridging has been replaced with Tunneled Window Connections to enable use of ID routing through the Global Space which may contain multiple PCIe BUS number spaces, and to provide enhanced security and scalability.

The communications model for TWC is the managed connection of a memory space aperture at the source host to one at the destination host. ID routed tunnels are configured between pairs of these windows allowing the source host to perform load and store accesses into the region of destination host memory exposed through its window. Sufficient windows are provided for static 1 to N and N to 1 connections on a rack scale fabric.

On higher scale fabrics, these connections must be managed dynamically as a limited resource. Look up tables indexed by connection numbers embedded in the address of the packets are used to manage the connections. Performing a source lookup provides the Global ID for routing. The destination look up table provides a mapping into the destination's address space and protection parameters.

In one embodiment, ExpressFabric™ augments the direct load/store capabilities provided by TWC with host-to-host messaging engines that allow use of standard network and clustering APIs. In one embodiment, a Message Passing Interface (MPI) driver uses low latency TWC connections until all its windows are in use, then implements any additional connections needed using RDMA primitives.

In one embodiment, security is provided by ReadEnable and WriteEnable permissions and an optional GID check at the target node. Connections between host nodes are made by the MCPU, allowing additional security mechanisms to be implemented in software.

### 1.3. Use of Vendor Defined Messaging and ID Routing

In one embodiment Capella 2's host-to-host messaging protocol includes transmission of a work request message to a destination DMA VF by a source DMA VF, the execution of the requested work by that DMA VF and then the return of a completion message to the source DMA VF with optional, moderated notification to the recipient as well. These messages appear on the wire as ID routed Vendor Defined Messages (VDMs). Message pull-protocol read requests that target the memory of a remote host are also sent as ID-routed VDMs. Since these are routed by ID rather than by address, the message and the read request created from it at the destination host can contain addresses in the destination's address domain. When a read request VDM reaches the target host port, it is changed to a standard read request and forwarded into the target host's space without address translation.

A primary benefit of ID routing is its easy extension to multiple PCIe bus number spaces by the addition of a Vendor Defined End-to-End Prefix containing source and destination bus number “Domain” ID fields as well as the destination BUS number in the destination Domain. Domain boundaries naturally align with packaging boundaries. Systems can be built wherein each rack, or each chassis within a rack, is a separate Domain with fully non-blocking connectivity between Domains.

Using ID routing for message engine transfers simplifies the address space, address mapping and address decoding logic, and enforcement of the producer/consumer ordering rules. The ExpressFabric™ Global ID is analogous to an Ethernet MAC address and, at least for purposes of tunneling Ethernet through the fabric, the fabric performs similarly to a Layer 2 Ethernet switch.

The ability to differentiate message engine traffic from other traffic allows use of relaxed ordering rules for message engine data transfers. This results in higher performance in scaled out fabrics. In particular, work request messages are considered strongly ordered while prefixed reads and their completions are unordered with respect to these or other writes. Host-to-host read requests and completion traffic can be spread over the redundant paths of a scaled out fabric to make best use of available redundant paths.

### 1.4. Integrated Virtualized DMA Engine and Messaging Protocol

ExpressFabric™ provides a DMA message engine for each host/server attached to the fabric and potentially for each guest OS running on each server. In one embodiment, the message engine is exposed to host software as a NIC endpoint against which the OS loads a networking driver. Each switch module of 16 lanes, (a station), contains a physical DMA engine managed by the management processor (MCPU) via an SR-IOV physical function (PF). A PF driver running on the MCPU enables and configures up to 64 DMA VFs and distributes them evenly among the host ports in the station.

### A. NIC and RDMA Modes

In one embodiment, the messaging protocol can employ a mix of NIC and RDMA message modes. In the NIC mode, messages are received and stored into the memory of the receiving host, just as would be done with a conventional NIC, and then processed by a standard TCP/IP protocol stack running on the host and eventually copied by the stack to an application buffer. Receive buffer descriptors consisting of just a pointer to the start of a buffer are stored in a Receive Buffer Ring in host memory. When a message is received, it is written to the address in the next descriptor in the ring. In one embodiment, a Capella 2 switch supports 4 KB receive buffers and links multiple buffers together to support longer NIC mode transfers. In one implementation, data is written into the same offset into the Rx buffer as its offset from a 512B boundary in the source memory in order to simplify the hardware.

In the RDMA mode, destination addresses are referenced via a Buffer Tag and Security Key at the receiving node. The Buffer Tag indexes into a data structure in host memory containing up to 64K buffer descriptors. Each buffer is a virtually contiguous memory region that can be described by any of:
A single scatter/gather list of up to 512 pointers to 4 KB pages (2 MB size)
A pointer to a list of SG lists (4 GB maximum buffer size)
A single physically contiguous region of up to 4 GB

RDMA as implemented is a secure and reliable zero copy operation from application buffer at the source to application buffer at the destination. Data is transferred in RDMA only if the security key and source ID in the Buffer Tag indexed data structure match corresponding fields in the work request message.

In one embodiment, RDMA transfers are also subject to a sequence number check maintained for up to 64K connections per port, but limited to 16K connections per station (1-4 host ports) in the Capella2 implementation to reduce cost. In one implementation, a RDMA connection is taken down immediately if an SEQ or security check fails or a non-correctable error is found. This guarantees that ordering is maintained within each connection.

### B. Notification of Message Delivery

In one embodiment, after writing all of the message data into destination memory, the destination DMA VF notifies the receiving host via an optional completion message (omitted by default for RDMA) and a moderated interrupt. Each station of the switch supports 256 Receive Completion Queues (RxCQs) that are divided among the 4 host ports in a station. The RxCQ, when used for RDMA, is specified in the Buffer Tag table entry. When NIC mode is used, an RxCQ hint is included in the work request message. In one implementation the RxCQ hint is hashed with source and destination IDs to distribute the work load of processing received messages over multiple CPU cores. When the message is sent via a socket connection, the RxCQ hint is meaningful and steers the notification to the appropriate processor core via the associated MSI-X interrupt vector.

The destination DMA VF returns notification to the source host in the form of a TxCQ VDM. The transmit hardware enforces a configurable limit on the number of TxCQ response messages outstanding as part of the congestion avoidance architecture. Both Tx and Rx completion messages contain SEQ numbers that can be checked by the drivers at each end to verify delivery. The transmit driver may initiate replay or recovery when a SEQ mismatch indicates a lost message. The TxCQ message also contains congestion feedback that the Tx driver software can use to adjust the rate at which it places messages to particular destinations in the Capella 2 switch's transmit queues.

1.5 Push vs. Pull Messaging

In one embodiment, a Capella 2 switch pushes short messages that fit within the supported descriptor size of 128B, or can be sent by a small number of such short messages sent in sequence, and pulls longer messages.

In push mode, these unsolicited messages are written asynchronously to their destinations, potentially creating congestion there when multiple sources target the same destination. Pull mode message engines avoid congestion by pushing only relatively short pull request messages that are completed by the destination DMA returning a read request for the message data to be transferred. Using pull mode, the sender of a message can avoid congestion due to multiple targets pulling messages from its memory simultaneously by limiting the number of outstanding message pull requests it allows. A target can avoid congestion at its local host's ingress port by limiting the number of outstanding pull protocol remote read requests. In a Capella 2 switch, both outstanding DMA work requests and DMA pull protocol remote read requests are managed algorithmically so as to avoid congestion.

Pull mode has the further advantage that the bulk of host-to-host traffic is in the form of read completions. Host-to-host completions are unordered with respect to other traffic and thus can be freely spread across the redundant paths of a multiple stage fabric. Partial read completions are relatively short allowing completion streams to interleave in the fabric with minimum latency impact on each other

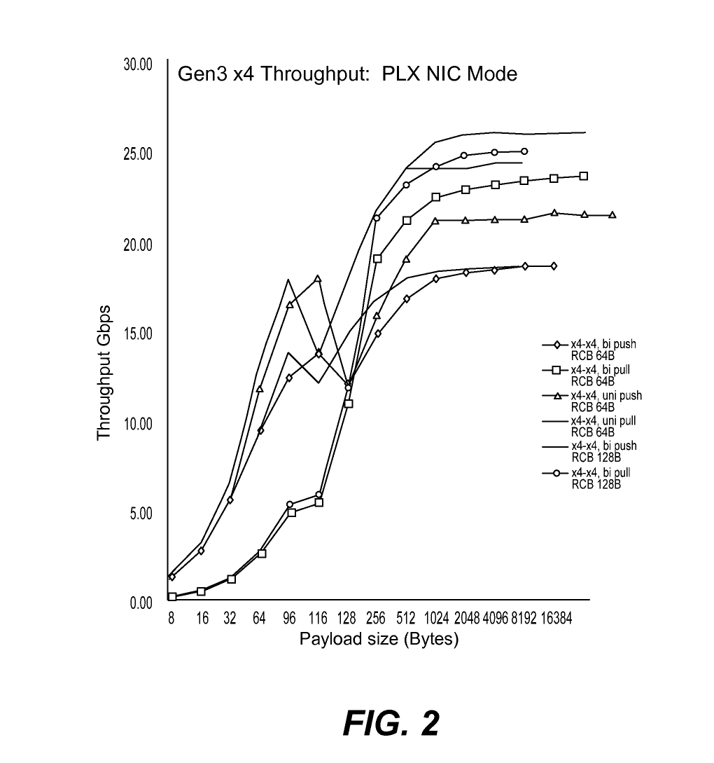

FIG. 2 illustrates throughput versus total message payload size in a Network Interface Card (NIC) mode for an embodiment of the present invention. Push versus pull modes are compared in a third generation (PCIe Gen 3) x4 links Dramatically higher efficiency is obtained using short packet push for message lengths less than 116B or so, with the crossover at approximately twice that. For sufficiently long transfers, throughput can be as much as 84% of wire speed including all overhead. The asymptotic throughput depends on both the partial completion size of communicating hosts and whether data is being transferred in only one direction.

An intermediate length message can be sent in NIC mode by either a single pull or a small number of contiguous pushes. The pushes are more efficient for short messages and lower latency, but have a greater tendency to cause congestion. The pull protocol has a longer latency, is more efficient for long messages and has a lesser tendency to cause congestion. The DMA driver receives congestion feedback in the transmit completion messages. It can adjust the push vs. pull threshold based on this limit in order to optimize performance. One can set the threshold to a relatively high value initially to enjoy the low latency benefits and then adjust it downwards if congestion feedback is received.

### 1.6 MR Sharing of SR-IOV Endpoints

In one embodiment, ExpressFabric™ supports the MR sharing of multifunction endpoints, including SR-IOV endpoints. This feature is called ExpressIOV. The same mechanisms that support ExpressIOV also allow a conventional, single function endpoint to be located in global space and assigned to any host in the same bus number Domain of the fabric. Shared I/O of this type can be used in ExpressFabric™ clusters to make expensive storage endpoints (e.g. SSDs) available to multiple servers and for shared network adapters to provide access into the general Ethernet and broadband cloud or into an Infiniband™ fabric.

The endpoints, are located in Global Space, attached to downstream ports of the switch fabric. In one embodiment, the PFs in these endpoints are managed by the vendor's PF driver running on the MCPU, which is at the upstream (management) port of its BUS number Domain in the Global Space fabric. Translations are required to map transactions between the local and global spaces. In one embodiment, a Capella 2 switch implements a mechanism called CSR Redirection to make those translations transparent to the software running on the attached hosts/servers. CSR redirection allows the MCPU to snoop on CSR transfers and in addition, to intervene on them when necessary to implement sharing.

This snooping and intervention is transparent to the hosts, except for a small incremental delay. The MCPU synthesizes completions during host enumeration to cause each host to discover its assigned endpoints at the downstream ports of a standard but synthetic PCIe fanout switch. Thus, the programming model presented to the host for I/O is the same as that host would see in a standard single host application with a simple fanout switch.

After each host boots and enumerates the virtual hierarchy presented to it by the fabric, the MCPU does not get involved again until/unless there is some kind of event or interrupt, such as an error or the hot plug or unplug of a host or endpoint. When a host has need to access control registers of a device, it normally does so in memory space. Those transactions are routed directly between host and endpoint, as are memory space transactions initiated by the endpoint.

Through CSR Redirection, the MCPU is able to configure ID routed tunnels between each host and the endpoint functions assigned to it in the switch without the knowledge or cooperation of the hosts. The hosts are then able to run the vendor supplied drivers without change.

MMIO requests ingress at a host port are tunneled downstream to an endpoint by means of an address trap. For each Base Address Register (BAR) of each I/O function assigned to a host, there is a CAM entry (address trap) that recognizes the host domain address of the BAR and supplies both a translation to the equivalent Global Space address and a destination BUS number for use in a Routing Prefix added to the Transaction Layer Packet (TLP).

Request TLPs are tunneled upstream from an endpoint to a host by Requester ID. For each I/O function RID, there is an ID trap CAM entry into which the function's Requester ID is associated to obtain the Global BUS number at which the host to which it has been assigned is located. This BUS number is again used as the Destination BUS in a Routing Prefix.

Since memory requests are routed upstream by ID, the addresses they contain remain in the host's domains; no address translations are needed. Some message requests initiated by endpoints are relayed through the MCPU to allow it to implement the message features independently for each host's virtual hierarchy.

These are the key mechanisms that enable ExpressIOV, formerly called MR-SRIOV.

ExpressFabric Routing Concepts

### 2.1 Port Types and Attributes

Referring again to FIG. 1, in one embodiment of ExpressFabric™, switch ports are classified into four types, each with an attribute. The port type is configured by setting the desired port attribute via strap and/or serial EEPROM and thus established prior to enumeration Implicit in the port type is a set of features/mechanisms that together implement the special functionality of the port type.

For Capella 2, the port types are:

1) A Management Port, which is a connection to the MCPU (upstream port 118 of FIG. 1);
2) A Downstream Port (port 120 of FIG. 1), which is a port where an end point device is attached, and which may include an ID trap for specifying upstream ID routes and an Address trap for specifying peer-to-peer ID routes;
3) A Fabric Port (port 115 of FIG. 1), which is a port that connects to another switch in the fabric, and which may implement ID routing and congestion management;
4) A Host Port (port 110 of FIG. 1), which is a port at which a host/server may be attached, and which may include address traps for specifying downstream ID routes and host to host ID routes via the TWC.

### 2.1.1 Management Port

In one embodiment, each switch in the fabric is required to have a single management port, typically the x1 port (port 118, illustrated in FIG. 1). The remaining ports may be configured to be downstream, fabric, or host ports. If the fabric consists of multiple switch chips, then each switch's management port is connected to a downstream of a fanout switch that has the MCPU at its upstream port. This forms a separate control plane. In some embodiments, configuration by the MCPU is done inband and carried between switches via fabric ports and thus a separate control plane isn't necessary.

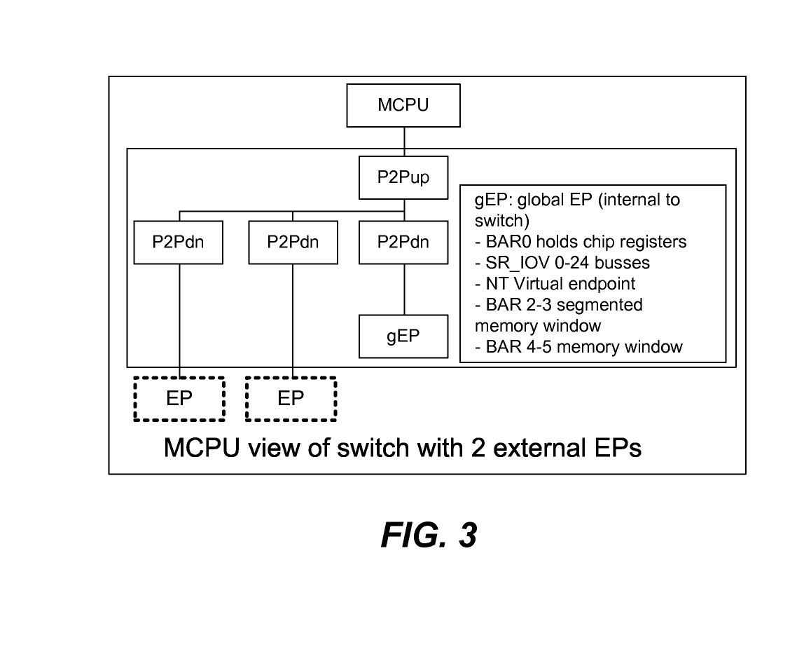

The PCIe hierarchy as seen by the MCPU looking into the management port is shown in FIG. 3, which illustrates the MCPU view of the switch. In this example, there are two external end points (EPs). The MCPU sees a standard PCIe switch with an internal endpoint, the Global Endpoint, (GEP), that contains switch management data structures and registers. In one embodiment, neither host ports nor fabric ports appear in the Configuration Space of the switch. This has the desirable effect of hiding them from the MCPU's BIOS, and OS and allowing them to be managed directly by the management software.

### A. The Tunneled Window Connection Management Endpoint

The TWC-M, also known as GEP is an internal endpoint through which both the switch chip and tunneled window connections between host ports are managed:

1) The GEP's BAR0 maps configuration registers into the memory space of the MCPU. These include the configuration space registers of the host and fabric ports that are hidden from the MCPU and thus not enumerated and configured by the BIOS or OS;
2) The GEP's Configuration Space includes a SR-IOV capability structure that claims a Global Space BUS number for each host port and its DMA VFs;
3) The GEP's 64-bit BAR2 decodes memory space apertures for each host port in Global Space. The BAR2 is segmented. Each segment is independently mapped to a single host and maps a portion of that host's local memory into Global Space;
4) The GEP serves as the management endpoint for Tunneled Window Connections and may be referred to in this context as the TWC-M; and
5) The GEP effectively hides host ports from the BIOS/OS running on the CPU, allowing the PLX management application to manage them. This hiding of host and fabric ports from the BIOS and OS to allow management by a management application solves an important problem and prevents the BIOS and OS from mismanaging the host ports.

In one embodiment, the management application software running on an MCPU, attached via each switch's management port, plays the following important roles in the system:

1) Configures and manages the fabric. The fabric ports are hidden from the MCPU's BIOS and/OS, and are managed via memory mapped registers in the GEP. Fabric events are reported to the MCPU via MSI from the GEPs of fabric switches;
2) Assigns endpoints (VFs) to hosts;
3) Processes redirected TLPs from hosts and provides responses to them;
4) Processes redirected messages from endpoints and hosts; and
5) Handles fabric errors and events.

### 2.1.2. Downstream Port

A downstream port 120 is where an endpoint may be attached. In one embodiment, an ExpressFabric™ downstream port is a standard PCIe downstream port augmented with data structures to support ID routing and with the encapsulation and redirection mechanism used in this case to redirect PCIe messages to the MCPU.

### 2.1.3 Host Port

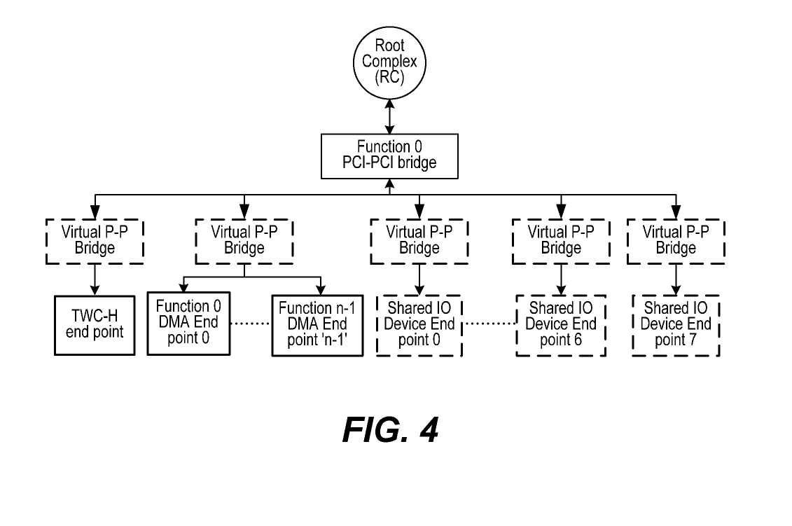

In one embodiment, each host port 110 includes one or more DMA VFs, a Tunneled Window Connection host side endpoint (TWC-H), and multiple virtual PCI-PCI bridges below which endpoint functions assigned to the host appear. The hierarchy visible to a host at an ExpressFabric™ host port is shown in FIG. 4, which illustrates a host port's view of the switch/fabric. A single physical PCI-PCI bridge is implemented in each host port of the switch. The additional bridges shown in FIG. 4 are synthesized by the MCPU using CSR redirection. Configuration space accesses to the upstream port virtual bridge are also redirected to the MCPU.

### 2.1.4 Fabric Port

The fabric ports 115 connect ExpressFabric™ switches together, supporting the multiple Domain ID routing, BECN based congestion management, TC queuing, and other features of ExpressFabric™.

In one embodiment, fabric ports are constructed as downstream ports and connected to fabric ports of other switches as PCIe crosslinks—with their SECs tied together. The base and limit and SEC and SUB registers of each fabric port's virtual bridge define what addresses and ID ranges are actively routed (e.g. by SEC-SUB decode) out the associated egress port for standard PCIe routes. TLPs are also routed over fabric links indirectly as a result of a subtractive decode process analogous to the subtractive upstream route in a standard, single host PCIe hierarchy. As discussed below in more detail, subtractive routing may be used for the case where a destination lookup table routing is invoked to choose among redundant paths.

In one embodiment, fabric ports are hidden during MCPU enumeration but are visible to the management software through each switch's Global Endpoint (GEP) described below and managed by it using registers in the GEP's BAR0 space.

### 2.2 Global Space

In one embodiment, the Global Space is defined as the virtual hierarchy of the management processor (MCPU), plus the fabric and host ports whose control registers do not appear in configuration space. TWC-H endpoint at each host port gives that host a memory window into Global Space and multiple windows in which it can expose some of its own memory for direct access by other hosts. Both the hosts themselves using load/store instructions and the DMA engines at each host port communicate using packets that are ID-routed through Global Space. Both shared and private I/O devices may be connected to downstream ports in Global Space and assigned to hosts, with ID routed tunnels configured in the fabric between each host and the I/O functions assigned to it.

### 2.2.1 Domains

In scaled out fabrics, the Global Space may be subdivided into a number of independent PCIe BUS number spaces called Domains. In such implementations, each Domain has its own MCPU. Sharing of SR-IOV endpoints is limited to nodes in the same Domain in the current implementation, but cross-Domain sharing is possible by augmenting the ID Trap data structure to provide both a Destination Domain and a Destination BUS instead of just a Destination BUS and by augmenting the Requester and Completer ID translation mechanism at host ports to comprehend multiple domains. Typically, Domain boundaries coincide with system packaging boundaries.

### 2.2.2 Global ID

Every function of every node (edge host or downstream port of the fabric) has a Global ID. If the fabric consists of a single Domain, then any I/O function connected to the fabric can be located by a 16-bit Global Requester ID (GRID) consisting of the node's Global BUS number and Function number. If multiple Domains are in use, the GRID is augmented by an 8-bit Domain ID to create a 24-bit GID.

### 2.2.3 Global ID Map

### 1. Host IDs

Each host port 110 consumes a Global BUS number. At each host port, DMA VFs use FUN 0 . . . NumVFs−1. X16 host ports get 64 DMA VFs ranging from 0 . . . 63. X8 host ports get 32 DMA VFs ranging from 0 . . . 31. X4 host ports get 16 DMA VFs ranging from 0 . . . 15.

The Global RID of traffic initiated by a requester in the RC connected to a host port is obtained via a TWC Local-Global RID-LUT. Each RID-LUT entry maps an arbitrary local domain RID to a Global FUN at the Global BUS of the host port. The mapping and number of RID LUT entries depends on the host port width as follows:

1) {HostGlobalBUS, 3′b111, EntryNum} for the 32-entry RID LUT of an x4 host port;
2) {HostGlobalBUS, 2′b11, EntryNum} for the 64 entry RID LUT of an x8 host port; and
3) {HostGlobalBUS, 1′b1, EntryNum} for the 128 entry RID LUT of an x16 host port.

The leading most significant 1's in the FUN indicate a non-DMA requester. One or more leading 0's in the fun at a host's Global BUS indicate that the FUN is a DMA VF.

### 2. Endpoint IDs

Endpoints, shared or unshared, may be connected at fabric edge ports with the Downstream Port attribute. Their FUNs (e.g. PFs and VFs) use a Global BUS between SEC and SUB of the downstream port's virtual bridge. At 2013's SRIOV VF densities, endpoints typically require a single BUS. ExpressFabric™ architecture and routing mechanisms fully support future devices that require multiple BUSs to be allocated at downstream ports.

For simplicity in translating IDs, fabric management software configures the system so that except when the host doesn't support ARI, the Local FUN of each endpoint VF is identical to its Global FUN. In translating between any Local Space and Global Space, its only necessary to translate the BUS number. Both Local to Global and Global to Local Bus Number Translation tables are provisioned at each host port and managed by the MCPU.

If ARI isn't supported, then Local FUN[2:0]==Global FUN[2:0] and Local Fun[7:3]==5′b000 00.

### 2.3 Navigating Through Global Space

In one embodiment, ExpressFabric™ uses standard PCIe routing mechanisms augmented to support redundant paths through a multiple stage fabric.

In one embodiment, ID routing is used almost exclusively within Global Space by hosts and endpoints, while address routing is sometimes used in packets initiated by or targeting the MCPU. At fabric edges, CAM data structures provide a Destination BUS appropriate to either the destination address or Requester ID in the packet. The Destination BUS, along with Source and Destination Domains, is put in a Routing Prefix prepended to the packet, which, using the now attached prefix, is then ID routed through the fabric. At the destination fabric edge switch port, the prefix is removed exposing a standard PCIe TLP containing, in the case of a memory request, an address in the address space of the destination. This can be viewed as ID routed tunneling.

Routing a packet that contains a destination ID either natively or in a prefix starts with an attempt to decode an egress port using the standard PCIe ID routing mechanism. If there is only a single path through the fabric to the Destination BUS, this attempt will succeed and the TLP will be forwarded out the port within whose SEC-SUB range the Destination BUS of the ID hits. If there are multiple paths to the Destination BUS, then fabric configuration will be such that the attempted standard route fails. For ordered packets, the destination lookup table (DLUT) Route Lookup mechanism described below will then select a single route choice. For unordered packets, the DLUT route lookup will return a number of alternate route choices. Fault and congestion avoidance logic will then select one of the alternatives. Choices are masked out if they lead to a fault, or to a hot spot, or to prevent a loop from being formed in certain fabric topologies. In one implementation, a set of mask filters is used to perform the masking. Selection among the remaining, unmasked choices is via a “round robin” algorithm.

The DLUT route lookup is used when the PCIe standard active port decode (as opposed to subtractive route) doesn't hit. The active route (SEC-SUB decode) for fabric crosslinks, is topology specific. For example, for all ports leading towards the root of a fat tree fabric, the SEC/SUB ranges of the fabric ports are null, forcing all traffic to the root of the fabric to use the DLUT Route Lookup. Each fabric crosslink of a mesh topology would decode a specific BUS number or Domain number range. With some exceptions, TLPs are ID-routed through Global Space using a PCIe Vendor Defined End-to-End Prefix. Completions and some messages (e.g. ID routed Vendor Defined Messages) are natively ID routed and require the addition of this prefix only when source and destination are in different Domains. Since the MCPU is at the upstream port of Global Space, TLPs may route to it using the default (subtractive) upstream route of PCIe, without use of a prefix. In the current embodiment, there are no means to add a routing prefix to TLPs at the ingress from the MCPU, requiring the use of address routing for its memory space requests. PCIe standard address and ID route mechanisms are maintained throughout the fabric to support the MCPU.

With some exceptions, PCIe message TLPs ingress at host and downstream ports are encapsulated and redirected to the MCPU in the same way as are Configuration Space requests. Some ID routed messages are routed directly by translation of their local space destination ID to the equivalent Global Space destination ID.

### 2.3.1. Routing Prefix

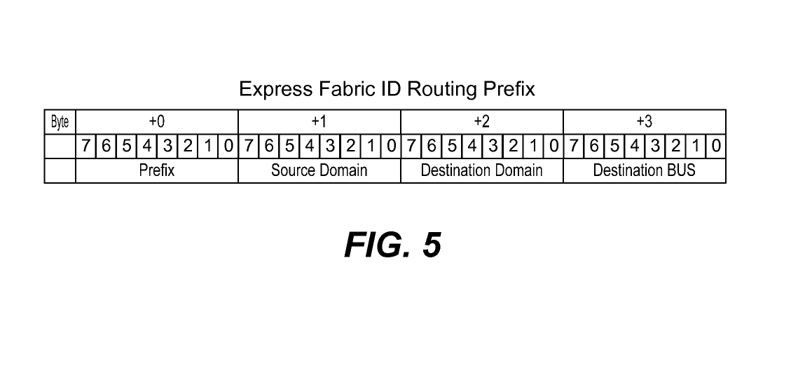

Support is provided to extend the ID space to multiple Domains. In one embodiment, an ID routing prefix is used to convert an address routed packet to an ID routed packet. An exemplary ExpressFabric™ Routing prefix is illustrated in FIG. 5.

A Vendor (PLX) Defined End-to-End Routing Prefix is added to memory space requests at the edges of the fabric. The method used depends on the type of port at which the packet enters the fabric and its destination:
At host ports:
   a. For host to host transfers via TWC, the TLUT in the TWC is used to lookup the appropriate destination ID based on the address in the packet (details in TWC patent app incorporated by reference)
   b. For host to I/O transfers, address traps are used to look up the appropriate destination ID based on the address in the packet, details in a subsequent subsection.
At downstream ports:
   a. For I/O device to I/O device (peer to peer) memory space requests, address traps are used to look up the appropriate destination ID based on the address in the packet, details in a subsequent subsection. If this peer to peer route look up hits, then the ID trap lookup isn't done.
   b. For I/O device to host memory space requests, ID Traps are used to look up the appropriate destination ID based on the Requester ID in the packet, details in a subsequent subsection.

The Address trap and TWC-H TLUT are data structures used to look up a destination ID based on the address in the packet being routed. ID traps associate the Requester ID in the packet with a destination ID:

1) In the ingress of a host port, by address trap for MMIO transfers to endpoints initiated by a host, and by TWC-H TLUT for host to host PIO transfers; and
2) In the ingress of a downstream port, by address trap for endpoint to endpoint transfers, by ID trap for endpoint to host transfers. If a memory request TLP doesn't hit a trap at the ingress of a downstream port, then no prefix is added and it address routes, ostensibly to the MCPU.

In one embodiment, the Routing Prefix is a single DW placed in front of a TLP header. Its first byte identifies the DW as an end-to-end vendor defined prefix rather than the first DW of a standard PCIe TLP header. The second byte is the Source Domain. The third byte is the Destination Domain. The fourth byte is the Destination BUS. Packets that contain a Routing Prefix are routed exclusively by the contents of the prefix.

Legal values for the first byte of the prefix are 9Eh or 9Fh, and are configured via a memory mapped configuration register.

### 2. Prioritized Trap Routing

Routing traps are exceptions to standard PCIe routing. In forwarding a packet, the routing logic processes these traps in the order listed below, with the highest priority trap checked first. If a trap hits, then the packet is forwarded as defined by the trap. If a trap doesn't hit, then the next lower priority trap is checked. If none of the traps hit, then standard PCIe routing is used.

### 1. Multicast Trap

The multicast trap is the highest priority trap and is used to support address based multicast as defined in the PCIe specification. This specification defines a Multicast BAR which serves as the multicast trap. If the address in an address routed packet hits in an enabled Multicast BAR, then the packet is forwarded as defined in the PCIe specification for a multicast hit.

### 2.3.2 Address Trap

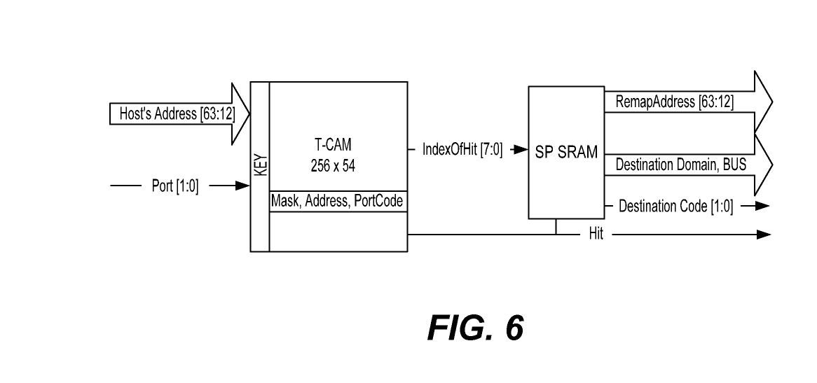

FIG. 6 illustrates the use of a ternary CAM (T-CAM) to implement address traps. Address traps appear in the ingress of host and downstream ports. In one embodiment they can be configured in-band only by the MCPU and out of band via serial EEPROM or I2C. Address traps are used for the following purposes:

1) Providing a downstream route from a host to an I/O endpoint using one trap per VF (or contiguous block of VFs) BAR;
2) Decoding a memory space access to host port DMA registers using one trap per host port;
3) Decoding a memory aperture in which TLPs are redirected to the MCPU to support BarO access to a synthetic endpoint; and
4) Supporting peer-to-peer access in Global Space.

Each address trap is an entry in a ternary CAM, as illustrated in FIG. 6. The T-CAM is used to implement address traps. Both the host address and a 2-bit port code are associated into the CAM. If the station has 4 host ports, then the port code identifies the port. If the station has only 2 host ports then the MSB of the port code is masked off in each CAM entry. If the station has a single host port, then both bits of the port code are masked off.

The following outputs are available from each address trap:

1) RemapOffset[63:12]. This address is added to the original address to affect an address translation. Translation by addition solves problem when one side of NT address is on a lower alignment than the size of the translation and in those cases, translation by replacement under mask will fail, e.g. a 4M aligned address with a size of 8M;
2) Destination{Domain,Bus}[15:0]. The Domain and BUS are inserted into a Routing Prefix that is used to ID route the packet when required per the CAM Code.

A CAM Code determines how/where the packet is forwarded, as follows:
a) 000=add ID routing prefix and ID route normally
b) 001=add ID routing prefix and ID route normally to peer
c) 010=encapsulate the packet and redirect to the MCPU
d) 011=send packet to the internal chip control register access mechanism
e) 1x0=send to the local DMAC assigning VFs in increasing order
f) 1x1=send to the local DMAC assigning VFs in decreasing order

If sending to the DMAC, then the 8 bit Destination BUS and Domain fields are repurposed as:

a) DestBUS field is repurposed as the starting function number of station DMA engine and
b) DestDomain field is repurposed as Number of DMA functions in the block of functions mapped by the trap.

### c) Address Trap Registers

Hardware uses this information along with the CAM code (forward or reverse mapping of functions) to arrive at the targeted DMA function register for routing, while minimizing the number of address traps needed to support multiple DMA functions.

The T-CAM used to implement the address traps appears as several arrays in the per-station global endpoint BAR0 memory mapped register space. The arrays are:
a) CAM Base Address lower
b) CAM Base Address upper
c) CAM Address Mask lower
d) CAM Address Mask upper
e) CAM Output Address lower
f) CAM Output Address upper
g) CAM Output Address Ctrl
h) CAM Output Address Rsvd

An exemplary array implementation is illustrated in the table below.

| | Default | | | | | |
|---|---|---|---|---|---|---|
| | Value | Attribute | EEPROM | Reset | | |
| Offset | (hex) | (MCPU) | Writable | Level | Register or Field Name | Description |
| | | | | | Address Mapping CAM | Address Trap |
| Array | 256 | 1 | | | | |
| E000h | | | | | CAM Base Address lower | |
| [2:0] | | RW | Yes | Level01 | CAM port | |
| [11:3] | | RsvdP | No | Level0 | | |
| [31:12] | | RW | Yes | Level01 | CAM Base Address 31-12 | |
| E004h | | | | | CAM Base Address upper | |
| [31:0] | | RW | Yes | Level01 | CAM Base Address 63-32 | |
| E008h | | | | | CAM Address Mask lower | |
| [2:0] | | RW | Yes | Level01 | CAM Port Mask | |
| [3] | | RW | Yes | Level01 | CAM Vld | |
| [11:3] | | RsvdP | No | Level0 | | |
| [31:12] | | RW | Yes | Level01 | CAM Address Mask 31-12 | |
| E00Ch | | | | | CAM Address Mask upper | |
| [31:0] | | RW | Yes | Level01 | CAM Port Mask 63-32 | |
| End | | | | | | EFFCh |
| Array | 256 | 1 | | | | |
| F000h | | | | | CAM Output Address lower | Mapped address part of the cam |
| | | | | | | lookup value |
| [5:0] | | RW | Yes | Level01 | CAM Address Size | |
| [11:6] | | RsvdP | No | Level0 | | |
| [31:12] | | RW | Yes | Level01 | CAM Output Xlat Address 31-12 | remap offset 31-12. value to add to |
| | | | | | | tlp address to get the cam xlated |
| | | | | | | address |
| F004h | | | | | CAM Output Address upper | Mapped address part of the cam |
| | | | | | | lookup value |
| [31:0] | | RW | Yes | Level01 | CAM Output Xlat Address 63-32 | remap offset 63-32 |
| F008h | | | | | CAM Output Address Ctrl | Mapped address part of the cam |
| | | | | | | lookup value |
| [7:0] | | RW | Yes | Level01 | Destination Bus | |
| [15:8] | | RW | Yes | Level01 | Destination Domain | |
| [18:16] | | RW | Yes | Level01 | CAM code | 0 = normal entry, 1 = peer to peer, |
| | | | | | | 2 = encap, 3 = chime, 4-7 = special |
| | | | | | | entries with bit0 = incremental |
| | | | | | | direction, bit1 = dma barentry |
| [24:19] | | RW | Yes | Level01 | vf start index | |
| [30:25] | | RW | Yes | Level01 | vf count | number of vf associated with this |
| | | | | | | entry-1. valid values are |
| | | | | | | 0/1/3/7/15/31/63 |
| [31] | | RW | Yes | Level01 | unused | |
| F00Ch | | | | | CAM Output Address Rsvd | Mapped address part of the cam |
| | | | | | | lookup value |
| [31:0] | | RsvdP | No | Level0 | | |
| End | | | | | | FFFCh |

### 2.3.3 ID Trap

ID traps are used to provide upstream routes from endpoints to the hosts with which they are associated. ID traps are processed in parallel with address traps at downstream ports. If both hit, the address trap takes priority.

Each ID trap functions as a CAM entry. The Requester ID of a host-bound packet is associated into the ID trap data structure and the Global Space BUS of the host to which the endpoint (VF) is assigned is returned. This BUS is used as the Destination BUS in a Routing Prefix added to the packet. For support of cross Domain I/O sharing, the ID Trap is augmented to return both a Destination BUS and a Destination Domain for use in the ID routing prefix.

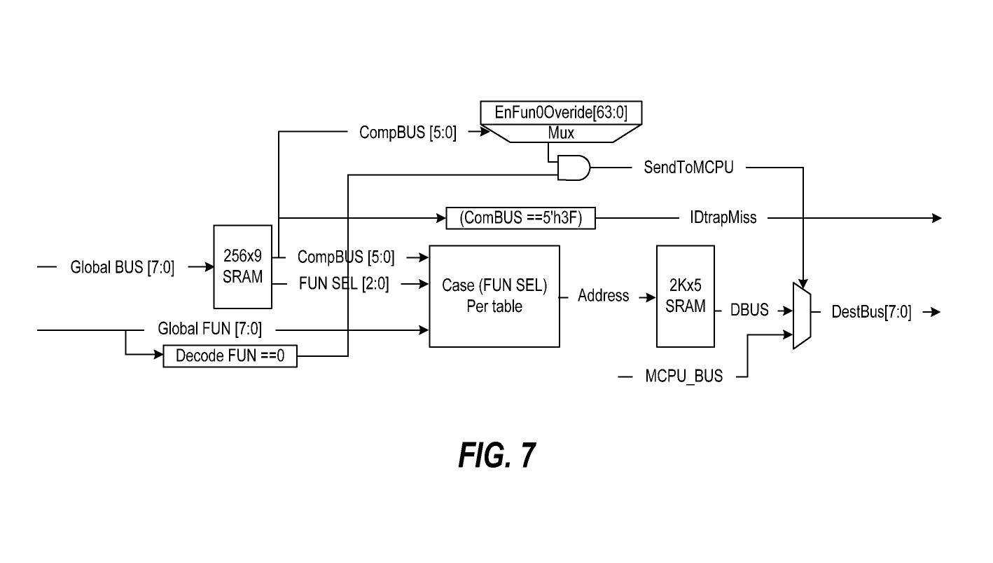

In a preferred embodiment, ID traps are implemented as a two-stage table lookup. Table size is such that all FUNs on at least 31 global busses can be mapped to host ports. FIG. 7 illustrates an implementation of ID trap definition. The first stage lookup compresses the 8 bit Global BUS number from the Requester ID of the TLP being routed to a 7-bit CompBus and a FUN_SEL code that is used in the formation of the second stage lookup, per the case statement of Table 1 Address Generation for 2nd Stage ID Trap Lookup. The FUN_SEL options allow multiple functions to be mapped in contiguous, power of two sized blocks to conserver mapping resources. Additional details are provided in the shared I/O subsection.

The table below illustrates address generation for 2nd stage 1D trap lookup.

| FUN SEL | Address Output | Application |
|---|---|---|
| 3′b000 | {CompBus[2:0], | Maps 256 FUNs on each of 8 busses |
| | GFUN[7:0]} | |
| 3′b001 | {CompBus[3:0], | Maps 128 FUNs on each of 16 busses |
| | GFUN[6:0]} | |
| 3′b010 | {CompBus[4:0], | Maps 64 FUNs on each of 32 busses |
| | GFUN[5:0]} | |
| 3′b011 | {CompBus[3:0], | Maps blocks of 2 VFs on 16 busses |
| | GFUN[7:1]} | |
| 3′b100 | {CompBus[4:0], | Maps blocks of 4 VFs on 32 busses |
| | GFUN[7:2]} | |
| 3′b101 | {CompBus[5:0], | Maps blocks of 8 VFs on 64 busses |
| | GFUN[7:3]} | |
| 3′b110 | Reserved | |
| 3′b111 | Reserved | |

ID traps in Register Space

The ID traps are implemented in the Upstream Route Table that appears in the register space of the switch as the three arrays in the per station GEP BAR0 memory mapped register space. The three arrays shown in the table below correspond to the two stage lookup process with FUN0 override described above.

The table below illustrates an Upstream Route Table Containing ID Traps.

| | Default | | | | | |
|---|---|---|---|---|---|---|
| | Value | Attribute | EEPROM | Reset | | |
| Offset | (hex) | (MCPU) | Writable | Level | Register or Field Name | Description |
| | | | | | Bus Number | ID Trap |
| | | | | | Compression RAM | |
| Array | 128 | | | | | |
| BC00h | | | | | USP_block_idx_even | |
| [5:0] | | RW | Yes | Level01 | Block Number for Bus | |
| [7:6] | | RsvdP | No | Level0 | | |
| [10:8] | | RW | Yes | Level01 | Function Select for Bus | |
| [11] | | RW | Yes | Level01 | SRIOV global bus flag | |
| [15:12] | | RsvdP | No | Level0 | | |
| BC02h | | | | | USP_block_idx_odd | |
| [5:0] | | RW | Yes | Level01 | Block Number for Bus | |
| [7:6] | | RsvdP | No | Level0 | | |
| [10:8] | | RW | Yes | Level01 | Function Select for Bus | |
| [11] | | RW | Yes | Level01 | SRIOV global bus flag | |
| [15:12] | | RsvdP | No | Level0 | | |
| End | | | | | | BDFCh |
| BE00h | | | | | Fun0Override_Blk0_31 | |
| [31:0] | | RW | Yes | Level01 | | |
| BE04h | | | | | Fun0Override_Blk32_63 | |
| [31:0] | | RW | Yes | Level01 | | |
| | | | | | Second Level Upstream | ID Trap |
| | | | | | Routing Table | |
| Array | 1024 | 1 | | | | |
| C000h | | | | | Entry_port_even | The even and odd dwords |
| | | | | | | must be written sequentially |
| | | | | | | for hardware to update the |
| | | | | | | memory |
| [7:0] | | RW | Yes | Level01 | Entry_destination_bus | |
| [15:8] | | RW | Yes | Level01 | Entry_destination_domain | |
| [16] | | RW | Yes | Level01 | Entry_vld | |
| [31:17] | | RsvdP | No | Level0 | | |
| C004h | | | | | Entry_port_odd | |
| [7:0] | | RW | Yes | Level01 | Entry_destination_bus | |
| [15:8] | | RW | Yes | Level01 | Entry_destination_domain | |
| [16] | | RW | Yes | Level01 | Entry_vld | |
| [31:17] | | RsvdP | No | Level0 | | |
| End | | | | | | DFFCh |

### 2.3.4 DLUT Route Lookup

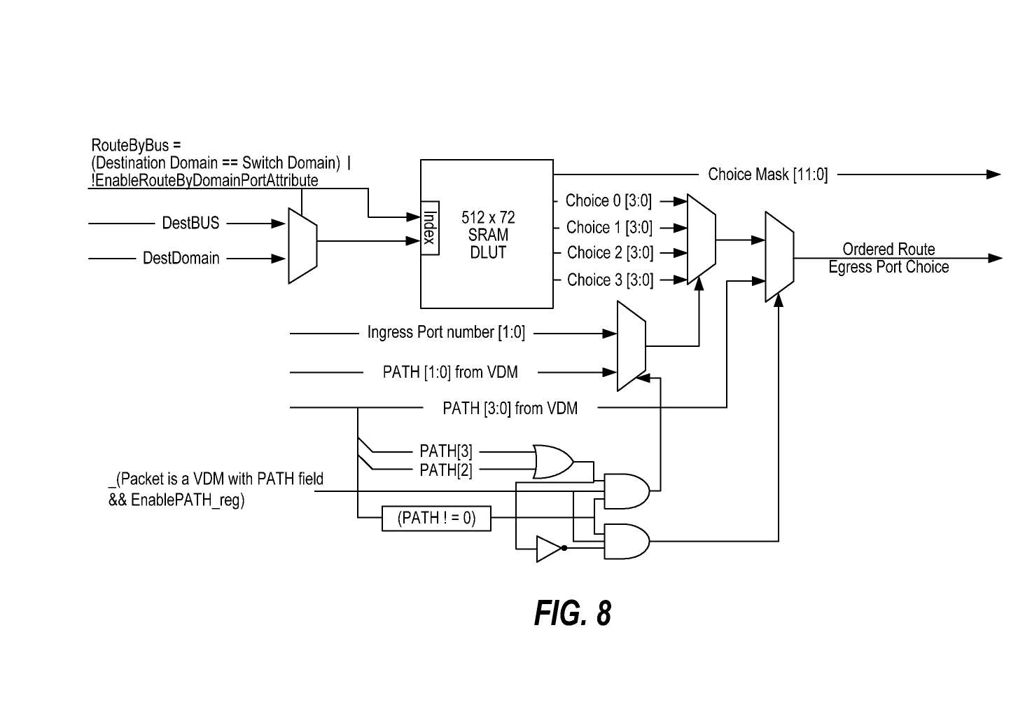

FIG. 8 illustrates a DLUT route lookup in accordance with an embodiment of the present invention. The Destination LUT (DLUT) mechanism, shown in FIG. 8, is used both when the packet is not yet in its Destination Domain, provided routing by Domain is not enabled for the ingress port, and at points where multiple paths through the fabric exist to the Destination BUS within that Domain, where none of the routing traps have hit. The EnableRouteByDomain port attribute can be used to disable routing by Domain at ports where this is inappropriate due to the fabric topology.

A 512 entry DLUT stores 4 4-bit egress port choices for each of 256 Destination BUSes and 256 Destination Domains. The number of choices stored at each entry of the DLUT is limited to four in our first generation product to reduce cost. Four choices is the practical minimum, 6 choices corresponds to the 6 possible directions of travel in a 3D Torus, and eight choices would be useful in a fabric with 8 redundant paths. Where there are more redundant paths than choices in the DLUT output, all paths can still be used by using different sets of choices in different instances of the DLUT in each switch and each module of each switch.

Since the Choice Mask has 12 bits, the number of redundant paths is limited to 12 in this initial silicon, which has 24 ports. A 24 port switch is suitable for use in CLOS networks with 12 redundant paths. In future products with higher port counts, a corresponding increase in the width of the Choice Mask entries will be made.

The Route by BUS is true when (Switch Domain==Destination Domain) or if routing by Domain is disabled by the ingress port attribute. Therefore, if the packet is not yet in its Destination Domain, then the route lookup is done using the Destination Domain rather than the Destination Bus as the D-LUT index, unless prohibited by the ingress port attribute.

In one embodiment, the D-LUT lookup provides four egress port choices that are configured to correspond to alternate paths through the fabric for the destination. DMA WR VDMs include a PATH field for selecting among these choices. For shared I/O packets, which don't include a PATH field or when use of PATH is disabled, selection among those four choices is made based upon which port the packet being routed entered the switch. The ingress port is associated with a source port and allows a different path to be taken to any destination for different sources or groups of sources.

The primary components of the D-LUT are two arrays in the per station BAR0 memory mapped register space of the GEP shown in the table below.

illustrates DLUT Arrays in Register Space

| | Default | | | | | |
|---|---|---|---|---|---|---|
| | Value | Attribute | EEPROM | Reset | Register or Field | |
| Offset | (hex) | (MCPU) | Writable | Level | Name | Description |
| Array | 256 | | | | | D-LUT table for 256 Domains |
| 800h | | | | | DLUT_DOMAIN_0 | D-LUT table entry for Domain 0 |
| [3:0] | 0 | RW | Yes | Level01 | Choice_0 | Valid values: 0-11; choice of 0xf implies broadcast |
| | | | | | | TLP - replicated to all stations |
| [7:4] | 3 | RW | Yes | Level01 | Choice_1 | Valid values: 0-11; choice of 0xf implies broadcast |
| | | | | | | TLP - replicated to all stations |
| [11:8] | 3 | RW | Yes | Level01 | Choice_2 | Valid values: 0-11; choice of 0xf implies broadcast |
| | | | | | | TLP - replicated to all stations |
| [15:12] | 3 | RW | Yes | Level01 | Choice_3 | Valid values: 0-11; choice of 0xf implies broadcast |
| | | | | | | TLP - replicated to all stations |
| [27:16] | 0 | RW | Yes | Level01 | Fault_vector | 1 bit per choice (12 choices); 0 = no fault; 1 = fault |
| | | | | | | for that choice - so avoid this choice. |
| [31:28] | 0 | RsvdP | No | Level01 | Reserved | |
| End | | | | | | BFCh |
| Array | 256 | | | | | D-LUT Table for 256 destination busses |
| C00h | | | | | DLUT_BUS_0 | D-LUT table entry for Destination Bus 0 |
| [3:0] | 0 | RW | Yes | Level01 | Choice_0 | Valid values: 0-11; choice of 0xf implies broadcast |
| | | | | | | TLP - replicated to all stations |
| [7:4] | 3 | RW | Yes | Level01 | Choice_1 | Valid values: 0-11; choice of 0xf implies broadcast |
| | | | | | | TLP - replicated to all stations |
| [11:8] | 3 | RW | Yes | Level01 | Choice_2 | Valid values: 0-11; choice of 0xf implies broadcast |
| | | | | | | TLP - replicated to all stations |
| [15:12] | 3 | RW | Yes | Level01 | Choice_3 | Valid values: 0-11; choice of 0xf implies broadcast |
| | | | | | | TLP - replicated to all stations |
| [27:16] | 0 | RW | Yes | Level01 | Fault_vector | 1 bit per choice (12 choices); 0 = no fault; 1 = fault |
| | | | | | | for that choice - so avoid this choice. |
| [31:28] | 0 | RsvdP | Yes | Level01 | Reserved | |
| End | | | | | | FFCh |

For host-to-host messaging, Vendor Defined Messages (VDMs), if use of PATH is enabled, then it can be used in either of two ways:

1) For a fat tree fabric, DLUT Route Lookup is used on switch hops leading towards the root of the fabric. For these hops, the route choices are destination agnostic. The present invention supports fat tree fabrics with 12 branches. If the PATH value in the packet is in the range 0 . . . 11, then PATH itself is used as the Egress Port Choice; and
2) If PATH is in the range 0xC . . . 0xF, as would be appropriate for fabric topologies other than fat tree, then PATH[1:0] are used to select among the four Egress Port Choices provided by the DLUT as a function of Destination BUS or Domain.

Note that if use of PATH isn't enabled, if PATH==0, or the packet doesn't include a PATH, then the low 2 bits of the ingress port number are used to select among the four Choices provided by the DLUT

In one embodiment, DMA driver software is configurable to use appropriate values of PATH in host to host messaging VDMs based on the fabric topology. PATH is intended for routing optimization in HPC where a single, fabric-aware application is running in distributed fashion on every compute node of the fabric.

In one embodiment, a separate array (not shown in FIG. 8), translates the logical Egress Port Choice to a physical port number.

### 2.3.5 Unordered Route

The DLUT Route Lookup described in the previous subsection is used only for ordered traffic. Ordered traffic consists of all host < > I/O device traffic plus the Work Request VDM and some TxCQ VDMs of the host to host messaging protocol. For unordered traffic, we take advantage of the ability to choose among redundant paths without regard to ordering. Traffic that is considered unordered is limited to types for which the recipients can tolerate out of order delivery. In one embodiment, unordered traffic types include only:

1) Completions (BCM bit set) for NIC and RDMA pull protocol remote read request VDMs. In one embodiment, the switches set the BCM at the host port in which completions to a remote read request VDM enter the switch.
2) NIC short packet push WR VDMs;
3) NIC short packet push TxCQ VDMs;
4) Remote Read request VDMs; and
5) (option) PIO write with RO bit set

Choices among alternate paths for unordered TLPs are made to balance the loading on fabric links and to avoid congestion signaled by both local and next hop congestion feedback mechanisms. In the absence of congestion feedback, each source follows a round robin distribution of its unordered packets over the set of alternate egress paths that are valid for the destination.

As seen above, the DLUT output includes a Choice Mask for each destination BUS and Domain. In one embodiment, choices are masked from consideration by the Choice Mask vector output from the DLUT for the following reasons:

1) The choice doesn't exist in the topology;
2) Taking that choice for the current destination will lead to a fabric fault being encountered somewhere along the path to the destination; and
3) Taking that choice creates a loop, which can lead to deadlock;

In fat tree fabrics, all paths have the same length. In fabric topologies that are grid-like in structure, such as 2D and 3D Torus, some paths are longer than others. For theses topologies, it is helpful to provide a single priority bit for each choice in the DLUT output. The priority bit is used as follows in the unordered route logic:

1) If no congestion is indicated, a “round robin” selection among the prioritized choices is done.
2) If congestion is indicated for only some prioritized Choices, the congested Choices are skipped in the round robin; and
3) If all prioritized choices are congested, then a random (preferred) or round robin selection among the non-prioritized choices is made.

It also is helpful in grid like fabrics where switch hops between the home Domain and the Destination Domain may be made at multiple switch stages along the path to the destination to process the route by Domain route Choices concurrently with the Route by BUS Choices and to defer routing by Domain at some fabric stages for unordered traffic if congestion is indicated for its route Choices and not for route by BUS route Choices. This deferment of route by Domain due to congestion feedback would be allowed for the first switch to switch hop of a path and would not be allowed if the route by Domain step is the last switch to switch hop required.

The Choice Mask Table shown below is part of the DLUT and appears in the per-chip BAR0 memory mapped register space of the GEP.

illustrates a Route Choice Mask Table.

| | Default | | | | | |
|---|---|---|---|---|---|---|
| | Value | Attribute | EEPROM | Reset | | |
| Offset | (hex) | (MCPU) | Writable | Level | Register or Field Name | Description |
| Array | 256 | | | | | |
| F0200h | | | | | ROUTE_CHOICE_MASK | |
| [23:0] | | RW | Yes | Level01 | Route_choice_mask | if set, the corresponding port to be |
| | | | | | | avoided for routing to the destination |
| | | | | | | bus or domain |
| [31:24] | | RsvdP | No | Level0 | Reserved | |
| End | | | | | | F05FCh |

In a fat tree fabric, the unordered route mechanism is used on the hops leading toward the root (central switch rank) of the fabric. Route decisions on these hops are destination agnostic. Fabrics with up to 12 choices at each stage are supported. During the initial fabric configuration, the Choice Mask entries of the DLUTs are configured to mask out invalid choices. For example, if building a fabric with equal bisection bandwidth at each stage and with x8 links from a 97 lane Capella 2 switch, there will be 6 choices at each switch stage leading towards the central rank. All the Choice Mask entries in all the fabric D-LUTs will be configured with an initial, fault-free value of 12′hFC0 to mask out choices 6 and up.

In a fabric with multiple unordered route choices that are not destination agnostic, unordered route choices are limited to the four 4-bit choice values output directly from the D-LUT. If some of those choices are invalid for the destination or lead to a fabric fault, then the appropriate bits of the Choice Mask[11:0] output from the D-LUT for the destination BUS or Domain being considered must be asserted. Unlike a fat tree fabric, this D-LUT configuration is unique for each destination in each D-LUT in the fabric.

Separate masks are used to exclude congested local ports or congested next hop ports from the round robin distribution of unordered packets over redundant paths. A congested local port is masked out independent of destination. Masking of congested next hop ports is a function of destination. Next hop congestion is signaled using a Vendor Specific DLLP as a Backwards Explicit Congestion Notification (BECN). BECNs are broadcast to all ports one hop backwards towards the edge of the fabric. Each BECN includes a bit vector indicating congested downstream ports of the switch generating the BECN. The BECN receivers use lookup tables to map each congested next hop port indication to the current stage route choice that would lead to it.

i. Local Congestion Feedback

Fabric ports indicate congestion when their fabric egress queue depth is above a configurable threshold. Fabric ports have separate egress queues for high, medium, and low priority traffic. Congestion is never indicated for high priority traffic; only for low and medium priority traffic.

Fabric port congestion is broadcasted internally from the fabric ports to all edge ports on the switch as an XON/XOFF signal for each {port, priority}, where priority can be medium or low. When a {port, priority} signals XOFF, then edge ingress ports are advised not to forward unordered traffic to that port, if possible. If, for example, all fabric ports are congested, it may not be possible to avoid forwarding to a port that signals XOFF.

Hardware converts the portX local congestion feedback to a local congestion bit vector per priority level, one vector for medium priority and one vector for low priority. High priority traffic ignores congestion feedback because by virtue of its being high priority, it bypasses traffic in lower priority traffic classes, thus avoiding the congestion. These vectors are used as choice masks in the unordered route selection logic, as described earlier.

For example, if a local congestion feedback from portX uses choice 1 and 5 and has XOFF set for low priority, then bits [1] and [5] of low local_congestion would be set. If a later local congestion from portY has XOFF clear for low priority, and portY uses choice 2, then bit[2] of low_local_congest would be cleared.

If all valid (legal) choices are locally congested, i.e. all l1, the local congestion filter applied to the legal_choices is set to all Os since we have to route the packet somewhere.

In one embodiment, any one station can target any of the six stations on a chip. Put another way, there is a fan-in factor of six stations to any one port in a station. A simple count of traffic sent to one port from another port cannot know what other ports in other stations sent to that port and so may be off by a factor of six. Because of this, one embodiment relies on the underlying round robin distribution method augmented by local congestion feedback to balance the traffic and avoid hotspots.

The hazard of having multiple stations send to the same port at the same time is avoided using the local congestion feedback. Queue depth reflects congestion instantaneously and can be fed back to all ports within the Inter-station Bus delay. In the case of a large transient burst targeting one queue, that Queue depth threshold will trigger congestion feedback which allows that queue time to drain. If the queue does not drain quickly, it will remain XOFF until it finally does drain.

Each source station should have a different choice_to_port map so that as hardware sequentially goes through the choices in its round robin distribution process, the next port is different for each station. For example, consider x16 ports with three stations 0,1,2 feeding into three choices that point to ports 12, 16, 20. If port 12 is congested, each station will cross the choice that points to port 12 off of their legal choices (by setting a choice_congested [priority]). It is desirable to avoid having all stations then send to the same next choice, i.e. port 16. If some stations send to port 16 and some to port 20, then the transient congestion has a chance to be spread out more evenly. The method to do this is purely software programming of the choice to port vectors. Station0 may have choice 1,2,3 be 12, 16, 20 while station1 has choice 1,2,3 be 12, 20, 16, and station 2 has choice 1,2,3 be 20, 12, 16.

A 512B completion packet, which is the common remote read completion size and should be a large percent of the unordered traffic, will take 134 ns to sink on an x4, 67 ns on x8, and 34.5 ns on x16. If we can spray the traffic to a minimum of 3x different x4 ports, then as long as we get feedback within 100 ns or so, the feedback will be as accurate as a count from this one station and much more accurate if many other stations targeted that same port in the same time period.

i.ii. Next Hop Congestion

For a switch from which a single port leads to the destination, congestion feedback sent one hop backwards from that port to where multiple paths to the same destination may exist, can allow the congestion to be avoided. From the point of view of where the choice is made, this is next hop congestion feedback.

For example, in a three stage Fat Tree, CLOS network, the middle switch may have one port congested heading to an edge switch. Next hop congestion feedback will tell the other edge switches to avoid this one center switch for any traffic heading to the one congested port.

For a non-fat tree, the next hop congestion can help find a better path. The congestion thresholds would have to be set higher, as there is blocking and so congestion will often develop. But for the traffic pattern where there is a route solution that is not congested, the next hop congestion avoidance ought to help find it.

Hardware will use the same congestion reporting ring as local feedback, such that the congested ports can send their state to all other ports on the same switch. A center switch could have 24 ports, so feedback for all 24 ports is needed

If the egress queue depth exceeds TOFF ns, then an XOFF status will be sent. If the queue drops back to TON ns or less, then an XON status will be sent. These times reflect the time required to drain the associated queue at the link bandwidth.

When TON<TOFF, hysteresis in the sending of BECNs results. However, at the receiver of the BECN, the XOFF state remains asserted for a fixed amount of time and then is de-asserted. This “auto XON” eliminates the need to send a BECN when a queue depth drops below TON and allows the TOFF threshold to be set somewhat below the round trip delay between adjacent switches.

For fabrics with more than three stages, next hop congestion feedback may be useful at multiple stages. For example, in a five stage Fat Tree, it can also be used at the first stage to get feedback from the small set of away-from-center choices at the second stage. Thus, the decision as to whether or not to used next hop congestion feedback is both topology and fabric stage dependent.

a PCIe vendor defined DLLP is used as a BECN to send next hop congestion feedback between switches. Every port that forwards traffic away from the central rank of a fat tree fabric will send a BECN if the next hop port stays in XOFF state. It is undesirable to trigger it too often.

### 1. BECN Information

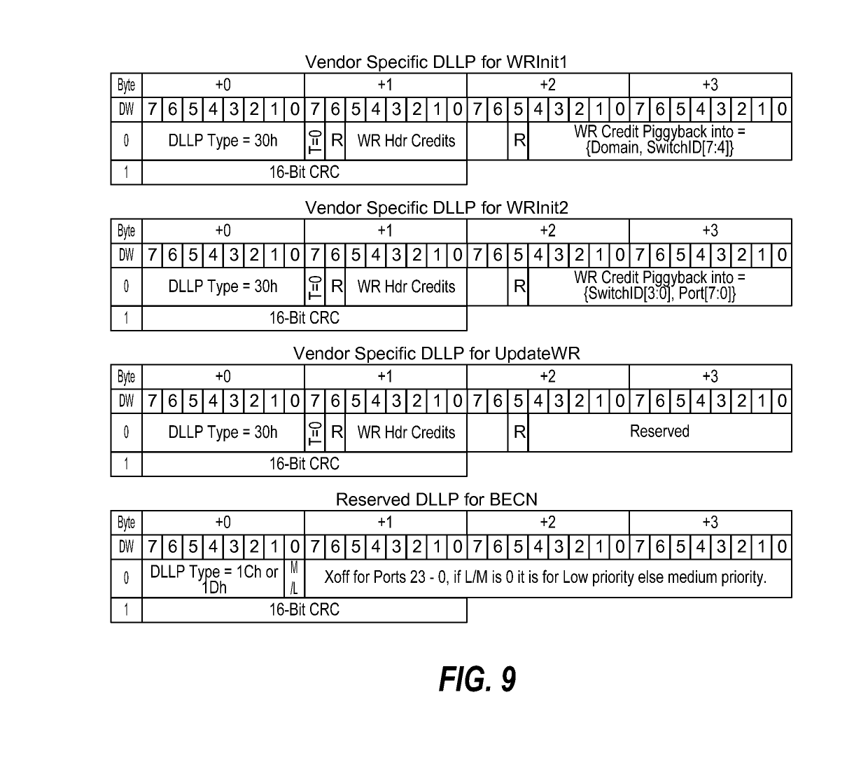

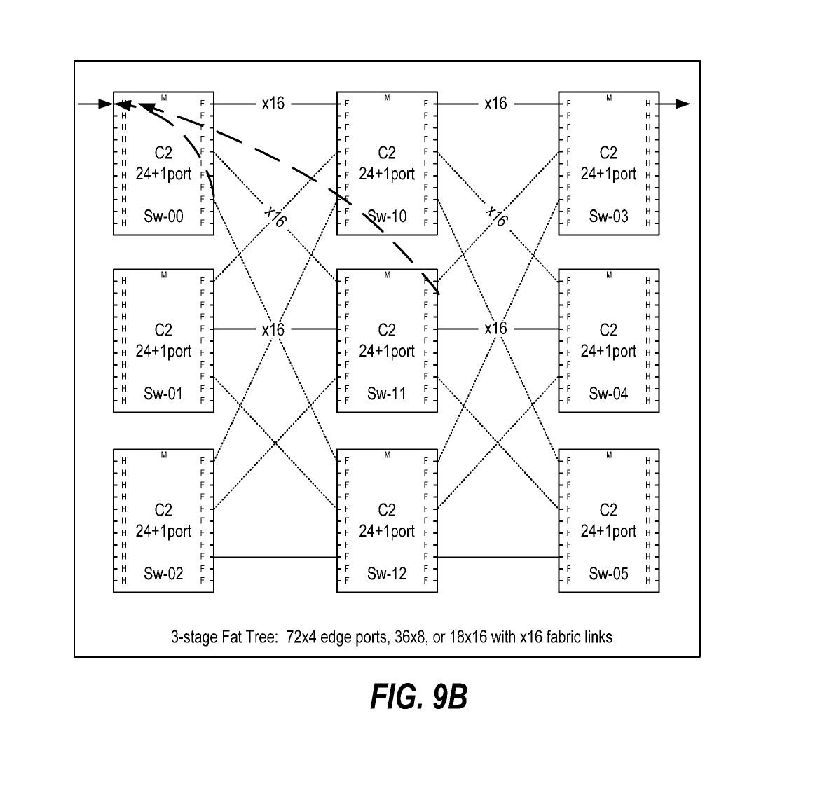

FIG. 9 illustrates a BECN packet format. BECN stands for Backwards Explicit Congestion Notification. It is a concept well known in the industry. Our implementation uses a BECN with a 24-bit vector that contains XON/XOFF bit for every possible port. BECNs are sent separately for low priority TC queues and medium priority TC queues. BECNs are not sent for high priority TC queues, which theoretically cannot congest.

BECN protocol uses the auto_XON method described earlier. A BECN is sent only if at least one port in the bit vector is indicating XOFF. XOFF status for a port is cleared automatically after a configured time delay by the receiver of a BECN. If a received BECN indicates XON, for a port that had sent an XOFF in the past which has not yet timed out, the XOFF for that port is cleared.

The BECN information needs to be stored by the receiver. The receiver will send updates to the other ports in its switch via the internal congestion feedback ring whenever a hop port's XON/XOFF state changes.

Like all DLLPs, the Vendor Defined DLLPs are lossy. If a BECN DLLP is lost, then the congestion avoidance indicator will be missed for the time period. As long as congestion persists, BECNs will be periodically sent. Since we will be sending Work Request credit updates, the BECN information can piggy back on the same DLLP.

### 2. BECN Receiver

Any port that receives a DLLP with new BECN information will need to save that information in its own XOFF vector. The BECN receiver is responsible to track changes in XOFF and broadcast the latest XOFF information to other ports on the switch. The congestion feedback ring is used with BECN next hop information riding along with the local congestion.

Since the BECN rides on a DLLP which is lossy, a BECN may not arrive. Or, if the next hop congestion has disappeared, a BECN may not even be sent. The BECN receiver must take care of ‘auto XON’ to allow for either of these cases.

One important thing for a receiver to not turn XON a next hop if it should stay off. Lost DLLPs are so rare as to not be a concern. However, DLLPs can be stalled behind a TLP and they often are. The BECN receiver must tolerate a Tspread+/−Jitter range, where Tspread is inverse of the transmitter BECN rate and Jitter is the delay due to TLPs between BECNs.

Upon receipt of a BECN for a particular priority level, a counter will be set to Tspread+Jitter. If the counter gets to 0 before another BECN of any type is received, then all XOFF of that priority are cleared. The absence of a BECN implies that all congestion has cleared at the transmitter. The counter measures the worst case time for a BECN to have been received if it was in fact sent.

The BECN receiver also sits on the on chip congestion ring. Each time slot it gets on the ring, it will send out any quartile state change information before sending out no-change. The BECN receiver must track which quartile has had a state change since the last time the on chip congestion ring was updated. The state change could be XOFF to XON or XON to XOFF. If there were two state changes or more, that is fine—record it as a state change and report the current value.

### 3. Ingress TLP and BECN

The ports on the current switch that receive BECN feedback on the inner switch broadcast will mark a bit in an array as ‘off.’ The array needs to be 12 choices x 24 ports.

It is reasonable to assume that the next hop will actively route by only bus or domain, not both, so only 256 entries are needed to get the next hop port number for each choice. The subtractive route decode choices need not have BECN feedback. A RAM with 256x (12*5b) is needed (and we have a 256x68b RAM, giving 8b of ECC).

### 4. Example

FIG. 9B illustrates a three stage Fat tree with 72x4 edge ports. Suppose that a TLP arrives in Sw-00 and is destined for destination bus DB which is behind Sw-03. There are three choices of mid-switch to route to, Sw-10, Sw-11, or Sw-12. However, the link from Sw-00 to Sw-12 is locally congested (red color with dashed line representing local congestion feedback). Additionally Sw-11 port to Sw-03 is congested (red color with dashed line representing next hop congestion feedback).

Sw-00 ingress station last sent an unordered medium priority TLP to Sw-10, so Sw-11 is the next unordered choice. The choices are set up as 1 to Sw-10, 2 to Sw-11, and 3 to Sw-12.

Case1: The TLP is an ordered TLP. D-LUT[DB] tells us to use choice1. Regardless of congestion feedback, a decision to route to choice1 leads to Sw-11 and even worse congestion.

Case2: The TLP is an unordered TLP. D-LUT[DB] shows that all 3 choices 1, 2, and 3 are unmasked but 4-12 are masked off. Normally we would want to route to Sw-11 as that is the next switch to spray unordered medium traffic to. However, a check on NextHop[DB] shows that choice2's next hop port would lead to congestion. Furthermore choice3 has local congestion. This leaves one ‘good choice’, choice1. The decision is then made to route to Sw-10 and update the last picked to be Sw-10.

Case3: A new medium priority unordered TLP arrives and targets Sw-04 destination bus DC. D-LUT[DC] shows all 3 choices are unmasked. Normally we want to route to Sw-11 as that is the next switch to spray unordered traffic to. NextHop[DC] shows that choice2's next hop port is not congested, choice2 locally is not congested, and so we route to Sw-11 and update the last routed state to be Sw-11.

### 5. Route Choice to Port Mapping

The final step in routing is to translate the route choice to an egress port number. The choice is essentially a logical port. The choice is used to index table below to translate the choice to a physical port number. Separate such tables exist for each station of the switch and may be encoded differently to provide a more even spreading of the traffic.

TABLE 5
Route Choice to Port Mapping Table

| | Default | | | | | |
|---|---|---|---|---|---|---|
| | Value | Attribute | EEPROM | Reset | | |
| Offset | (hex) | (MCPU) | Writable | Level | Register or Field Name | Description |
| 1000h | | | | | Choice_mapping_0_3 | Choice to port mapping |
| | | | | | | entries for choices 0 to 3 |
| [4:0] | 0 | RW | Yes | Level01 | Port_for_choice_0 | |
| [7:5] | 0 | RsvdP | No | Level01 | Reserved | |
| [12:8] | 0 | RW | Yes | Level01 | Port_for_choice_1 | |
| [15:13] | 0 | RsvdP | No | Level01 | Reserved | |
| [20:16] | 0 | RW | Yes | Level01 | Port_for_choice_2 | |
| [23:21] | 0 | RsvdP | No | Level01 | Reserved | |
| [28:24] | 0 | RW | Yes | Level01 | Port_for_choice_3 | |
| [31:29] | 0 | RsvdP | No | Level01 | Reserved | |
| 1004h | | | | | Choice_mapping_4_7 | Choice to port mapping |
| | | | | | | entries for choices 4 to 7 |
| [4:0] | 0 | RW | Yes | Level01 | Port_for_choice_4 | |
| [7:5] | 0 | RsvdP | No | Level01 | Reserved | |
| [12:8] | 0 | RW | Yes | Level01 | Port_for_choice_5 | |
| [15:13] | 0 | RsvdP | No | Level01 | Reserved | |
| [20:16] | 0 | RW | Yes | Level01 | Port_for_choice_6 | |
| [23:21] | 0 | RsvdP | No | Level01 | Reserved | |
| [28:24] | 0 | RW | Yes | Level01 | Port_for_choice_7 | |
| [31:29] | 0 | RsvdP | No | Level01 | Reserved | |
| 1008h | | | | | Choice_mapping_11_8 | Choice to port mapping |
| | | | | | | entries for choices 8 to |
| | | | | | | 11 |
| [4:0] | 0 | RW | Yes | Level01 | Port_for_choice_8 | |
| [7:5] | 0 | RsvdP | No | Level01 | Reserved | |
| [12:8] | 0 | RW | Yes | Level01 | Port_for_choice_9 | |
| [15:13] | 0 | RsvdP | No | Level01 | Reserved | |
| [20:16] | 0 | RW | Yes | Level01 | Port_for_choice_10 | |
| [23:21] | 0 | RsvdP | No | Level01 | Reserved | |
| [28:24] | 0 | RW | Yes | Level01 | Port_for_choice_11 | |
| [31:29] | 0 | RsvdP | No | Level01 | Reserved | |

### 6. DMA Work Request Flow Control

In ExpressFabric™, it is necessary to implement flow control of DMA WR VDMs in order to avoid deadlock that would occur if a DMA WR VDM that could not be executed or forwarded, blocked a switch queue. When no WR flow control credits are available at an egress port, then no DMA WR VDMs may be forwarded. In this case, other packets bypass the stalled DMA WR VDMs using a bypass queue. It is the credit flow control plus the bypass queue mechanism that together allow this deadlock to be avoided.

In one embodiment, a Vendor Defined DLLP is used to implement a credit based flow control system that mimics standard PCIe credit based flow control.

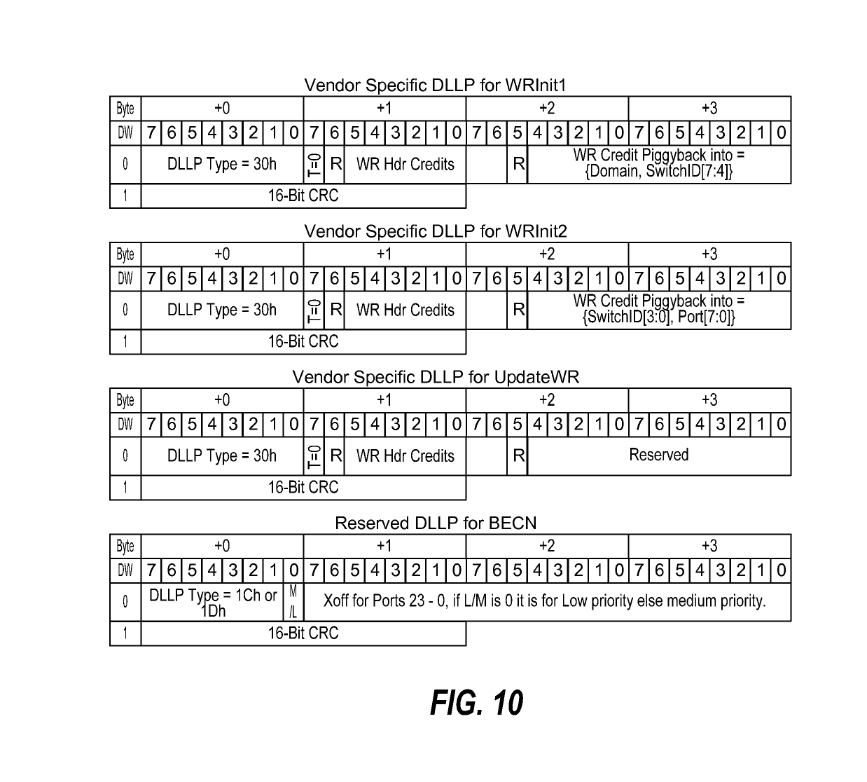

FIG. 10 illustrates an embodiment of Vendor Specific DLLP for WR Credit Update. The packet format for the flow control update is illustrated below. The WR Init 1 and WR Init 2 DLLPs are sent to initialize the work request flow control system while the UpdateWR DLLP is used during operation to update and grant additional flow control credits to the link partner, just as in standard PCIe for standard PCIe credit updates.

### 7. Topology Discovery Mechanism

To facilitate fabric management, a mechanism is implemented that allows the management software to discover and/or verify fabric connections. A switch port is uniquely identified by the {Domain ID, Switch ID, Port Number} tuple, a 24-bit value. Every switch sends this value over every fabric link to its link partner in two parts during initialization of the work request credit flow control system, using the DLLP formats defined in FIG. 10. After flow control initialization is complete, the {Domain ID, Switch ID, Port Number} of the connected link partner can be found, along with Valid bits, in a WRC_Info_Rcvd register associated with the Port. The MCPU reads the connectivity information from the WRC_Info_Rcvd register of every port of every switch in the fabric and with it is able to build a graph of fabric connectivity which can then be used to configure routes in the DLUTs.

### 8. TC Queuing

In one embodiment, ExpressFabric™ switches implement multiple TC-based egress queues. For scheduling purposes, these queues are classified as high, medium, or low priority. In accordance with common practice, the high and low priority queues are scheduled are a strict priority basis while a weighted RR mechanism that guarantees a minimum BW for each queue is used for the medium priority queues.

Ideally, a separate set of flow control credits would be maintained for each egress queue class. In standard PCIe, this is done with multiple virtual channels. To avoid the cost and complexity of multiple VCs, the scheduling algorithm is modified according to how much credit has been granted to the switch by its link partner. If the available credit is greater than or equal to a configurable threshold, then the scheduling is done as described above. If the available credit is below the threshold, then only high priority packets are forwarded. That is, in one embodiment the forwarding policy is based on credit advertisement from a link partner, which indicates how much room it has its ingress queue.

### 9. TC Translation at Host and Downstream Ports

In one embodiment TC translation is provided at host and downstream ports. In PCIe, TC0 is the default TC. It is common practice for devices to support only TC0, which makes it difficult to provide differentiated services in a switch fabric. To allow I/O traffic to be separated by TC with differentiated services, TC translation is implemented at downstream and host ports in such a way that packets can be given an arbitrary TC for transport across the fabric but have the original TC, which equals TC0, at both upstream (host) ports and downstream ports.

For each downstream port, a TC_translation register is provided. Every packet ingress at a downstream port for which TC translation is enabled will have its traffic class label translated to the TC translation register's value. Before being forwarded from the downstream port's egress to the device, the TC of every packet will be translated to TC0.

At host ports, the reverse of this translation is done. An 8-bit vector identifies those TC values that will be translated to TC0 in the course of forwarding the packet upstream from the host port. If the packet is a non-posted request, then an entry will be made for it in a tag-indexed read tracking scoreboard and the original TC value of the NP request will be stored in the entry. When the associated completion returns to the switch, its TC will be reverse translated to the value stored in the scoreboard entry at the index location given by the TAG field of the completion TLP.

With TC translation as described above, one can map storage, networking, and host to host traffic into different traffic classes, provision separate egress TC queues for each such class, and provide minimum bandwidth guarantees for each class.

TC translation can be enabled on a per downstream port basis or on a per function basis. It is enabled for a function only if the device is known to use only TC0 and for a port only if all functions accessed through the port use only TC0.

### 10. Use of Read Tracking and Completion Synthesis at Fabric Ports

In standard PCIe, it is well known to use a read tracking scoreboard to save state about every non-posted request that has been forwarded from a downstream port. If the device at the downstream becomes disconnected the saved state is used to synthesize and return a completion for every outstanding non-posted request tracked by the scoreboard. This avoids a completion timeout, which could cause the operating system of the host computer to “crash.”

When I/O is done across a switch fabric, then the same read tracking and completion synthesis functionality is required at fabric ports to deal with potential completion timeouts when, for example, a fabric cable is surprise removed. To do this, it is necessary to provide a guarantee that, when the fabric has multiple paths, each completion takes the same path in reverse as taken by the non-posted request that it completes. To provide such a guarantee, a PORT field is added to each entry of the read tracking scoreboard. When the entry used to track a non-posted request is first created, the PORT field is populated with the port number at which it entered the switch. When the completion to the request is processed, the completion is forwarded out the port whose number appears in the PORT field.

### Partial Summary of Features/Subfeatures

Embodiments of the present invention include numerous features that can be used in new ways. Some of the sub-features are summarized in the table below.

| Feature | Subfeature |
|---|---|
| Fabric | Use of ID routing - for both ID routed and address |
| | routed packets |
| | Using ID routing prefix in VDM in compliance with |
| | standards while adding new functionality |
| | DomainID expands ID name space by 8-bits and the |
| | scalability of the fabric by 2\hat{ }8 |
| | Convert from address route to ID route at fabric edge |
| | Prioritized Trap Routing (in the following order:) |
| | Multicast Trap |
| | Address Trap |
| | ID Trap |
| | Static spread route ordered paths |
| | Dynamic route of unordered traffic |
| | Use of BCM bit to identify unordered completions. |
| | The BCM bit is an existing defined bit of the PCIe |
| | header, Byte Count Modified, as a flag for PLX to |
| | PLX remote read completions. BCM |
| | Active local and remote congestion feedback |
| | User defined DLLP for BECN and WR flow control |
| | User defined DLLP with ID fields that support |
| | identification and verification of fabric topology by |
| | MCPU - auto discovery of fabric topology enabled by |
| | this, and helps in setting up dynamic routes |
| | Data structures used to associate BECN feedback with |
| | forward routes for avoiding congestion hot spots |
| | Skip congested route Choices in the round robin spread |
| | of unordered traffic |
| | Choice Mask and its use to break loops and steer traffic |
| | away from faults or congestion |
| | Read Tracking Scoreboard and completion synthesis - |
| | building block for a better behaved fabric when fabric |
| | links are removed or when they fail. |
| | store ingress port# in read tracking Scoreboard so can |
| | guarantee read completion returns by reverse of path |
| | taken by read request. This is used to route the |
| | completion back the way the read request came from - |
| | exactly the same path, regardless of possible D-LUT |
| | programming mistakes. The same path is needed for |
| | ReadTracking accounting. |
| | WR outstanding limit used with TxCQ messages for |
| | end to end flow control |
| | Source Rate limiting mechanism |
| | Guaranteed BW per TxQ |
| | Broadcast Domain IDs and use thereof: Domain ID |
| | 0xFF and Bus ID 0xFF are reserved for |
| | broadcast/multicast packet use, as routing ID |
| | components. |
| | TC translation at downstream ports - to separate traffic |
| | in the fabric on a per device basis, to apply different |
| | QOS settings. |
| | TC Queuing with last credits reserved for highest |
| | priority class |
| | Priority bit for each route choice. If there are |
| | numerous route choices, there may be a ‘best’ choice |
| | and a list of ‘backup’ choices. The best choice should |
| | be indicated. Only if the best choice is congested |
| | would an alternate choice be used. |
| | Random unmasked route choice if prioritized choices |
| | are congested |
| | Weighted round-robin among these choices for |
| | congestion avoidance |

1. ID Routed Broadcast

1. Broadcast/Multicast Usage Models

In one embodiment, support is provided for broadcast and multicast in a Capella switch fabric. Broadcast is used in support of networking (Ethernet) routing protocols and other management functions. Broadcast and multicast may also be used by clustering applications for data distribution and synchronization.

Routing protocols typically utilize short messages. Audio and video compression and distribution standards employ packets just under 256 bytes in length because short packets result in lower latency and jitter. However, while a Capella switch fabric might be at the heart of a video server, the multicast distribution of the video packets is likely to be done out in the Ethernet cloud rather than in the ExpressFabric.

In HPC and instrumentation, multicast may be useful for distribution of data and for synchronization (e.g. announcement of arrival at a barrier). A synchronization message would be very short. Data distribution broadcasts would have application specific lengths but can adapt to length limits.

There are at best limited applications for broadcast/multicast of long messages and so these won't be supported directly. To some extent, BC/MC of messages longer than the short packet push limit may be supported in the driver by segmenting the messages into multiple SPPs sent back to back and reassembled at the receiver.

Standard MC/BC routing of Posted Memory Space requests is required to support dualcast for redundant storage adapters that use shared endpoints.

2. Broadcast/Multicast of DMA VDMs

One embodiment of Capella-2 extends the PCIe Multicast (MC) ECN specification, by PCIe-Sig, to support multicast of the ID-routed Vendor Defined Messages used in host to host messaging and to allow broadcast/multicast to multiple Domains.

The following approach may be used to support broadcast and multicast of DMA VDMs in the Global ID space:
Define the following BC/MC GIDs:
   Broadcast to multiple Domains uses a GID of {0FFh, 0FFh, 0FFh}
   Multicast to multiple Domains uses a GID of {0FFh, 0FFh, MCG}
      Where the MCG is defined per the PCIe Specification MC ECN
   Broadcast confined to the home Domain uses a GID of {HomeDomain, 0FFh, 0FFh}
   Multicast confined to the home Domain uses a GID of {HomeDomain, 0FFh, MCG}
Use the FUN of the destination GRID of a DMA Short Packet Push VDM as the Multicast Group number (MCG).
   Use of 0FFh as the broadcast FUN raises the architectural limit to 256 MCGs
   In one embodiment, Capella supports 64 MCGs defined per the PCIe specification MC ECN
Multicast/broadcast only short packet push ID routed VDMs
   At a receiving host, DMA MC packets are processed as short packet pushes. The PLX message code in the short packet push VDM can be NIC, CTRL, or RDMA Short Untagged. If a BC/MC message with any other message code is received, it is rejected as malformed by the destination DMAC.

With these provisions, software can create and queue broadcast packets for transmission just like any others. The short MC packets are pushed just like unicast short packets but the multicast destination IDs allow them to be sent to multiple receivers.

Standard PCIe Multicast is unreliable; delivery isn't guaranteed. This fits with IP multicasting which employs UDP streams, which don't require such a guarantee. Therefore, in one embodiment a Capella switch fabric will not expect to receive any completions to BC/MC packets as the sender and will not return completion messages to BC/MC VDMs as a receiver. The fabric will treat the BC/MC VDMs as ordered streams (unless the RO bit in the VDM header is set) and thus deliver them in order with exceptions due only to extremely rare packet drops or other unforeseen losses.

When a BC/MC VDM is received, the packet is treated as a short packet push with nothing special for multicast other than to copy the packet to ALL VFs that are members of its MCG, as defined by a register array in the station. The receiving DMAC and the driver can determine that the packet was received via MC by recognition of the MC value in the Destination GRID that appears in the RxCQ message.

3. Broadcast Routing and Distribution

Broadcast/multicast messages are first unicast routed using DLUT provided route Choices to a “Domain Broadcast Replication Starting Point (DBRSP)” for a broadcast or multicast confined to the home domain and a “Fabric Broadcast Replication Starting Point (FBRSP)” for a fabric consisting of multiple domains and a broadcast or multicast intended to reach destinations in multiple Domains.

Inter-Domain broadcast/multicast packets are routed using their Destination Domain of 0FFh to index the DLUT. Intra-Domain broadcast/multicast packets are routed using their Destination BUS of 0FFh to index the DLUT. PATH should be set to zero in BC/MC packets. The BC/MC route Choices toward the replication starting point are found at D-LUT[{1, 0xff}] for inter-Domain BC/MC TLPs and at D-LUT[{0, 0xff}] for intra-Domain BC/MC TLPs. Since DLUT Choice selection is based on the ingress port, all 4 Choices at these indices of the DLUT must be configured sensibly.

Since different DLUT locations are used for inter-Domain and intra-Domain BC/MC transfers, each can have a different broadcast replication starting point. The starting point for a BC/MC TLP that is confined to its home Domain, DBRSP, will typically be at a point on the Domain fabric where connections are made to the inter-Domain switches, if any. The starting point for replication for an Inter-Domain broadcast or multicast, FBRSP, is topology dependent and might be at the edge of the domain or somewhere inside an Inter-Domain switch.

At and beyond the broadcast replication starting point, this DLUT lookup returns a route Choice value of 0xFh. This signals the route logic to replicate the packet to multiple destinations.
If the packet is an inter-Domain broadcast, it will be forwarded to all ports whose Interdomain_Broadcast_Enable port attribute is asserted.
If the packet is an inter-Domain broadcast, it will be forwarded to all ports whose Intradomain_Broadcast_Enable port attribute is asserted. (wherein in one embodiment an Intradomain Broadcast Enable corresponds to a DMA BROADCAST Enable)
For multicast packets, as opposed to broadcast packets, the multicast group number is present in the Destination FUN. If the packet is a multicast, destination FUN !=0FFh, it will be forwarded out all ports whose PCIe Multicast Capability Structures are member of the multicast group of the packet and whose Interdomain_Broadcast_Enable or Intradomain_Broadcast_Enable port attribute is asserted.

1. Avoidance of Loops

The challenge for the broadcast is to not create loops, so the edge of the broadcast cloud (where broadcast replication ceases) needs to be well defined. Loops are avoided by appropriate configuration of the Intradomain_Broadcast_Enable and Interdomain_Broadcast_Enable attributes of each port in the fabric.

2. Broadcast/multicast Replication in a Fat Tree Fabric

For a single Domain fat tree, broadcast may start from switch on the central rank of the fabric. The broadcast distribution will start there, proceed outward to all edge switches and stop at the edges. Only one central rank switch will be involved in the operation.

For a multiple Domain 3D fat tree, unicast route for a Destination Domain of 0xFFh should be configured in the DLUT towards any switch on the central rank of the Inter-Domain fabric or to any switch of the Inter-Domain fabric if that fabric has a single rank. The ingress of that switch will be the FBRSP, broadcast/multicast replication starting point for Inter-Domain broadcasts and multicasts.

The unicast route for a Destination BUS of 0xFFh should follow the unicast route for a Destination Domain of 0xFFh. The replication starting point for Intra-Domain broadcasts and multicasts for each Domain will then be at the inter-Domain edge of this route.

3. Broadcast/Multicast Replication in a Mesh Fabric

In a mesh fabric, a separate broadcast replication starting points can be configured for each sub-fabric of the mesh. Any switch on the edge (or as close to the edge as possible) of the sub-fabric from which ports lead to all the sub-fabrics of the mesh can be used. The same point can be used for both intra-Domain and inter-Domain replication. For the former, the TLP will be replicated back into the Domain on ports whose “Inter-Domain Routing Enable” attribute is clear. For the latter, the TLP will be replicated out of the Domain on ports whose “Inter-Domain Routing Enable” attribute is set.

4. Broadcast/multicast Replication in a 2-D or 3-D Torus

In a 2-D or 3-D torus, any switch can be assigned as a start point. The key is that one and only one is so assigned. From the start point, the ‘broadcast edges’ can be defined by clearing the attributes of Intradomain_Broadcast_Enable and Interdomain_Broadcast_Enable attributes at points on the Torus at 1800 around the physical loops from the starting point.

5. Management of the MC Space

The management processor (MCPU) will manage the MC space. Hosts communicate with the MCPU as will eventually be defined in the management software architecture specification for the creation of MCGs and configuration of MC space. In one embodiment a Tx driver converts Ethernet multicast MAC addresses into ExpressFabric™ multicast GIDs.

In one embodiment, address and ID based multicast share the same 64 multicast groups, MCGs, which must be managed by a central/dedicated resource (e.g. the MCPU). When the MCPU allocates an MCG on request from a user (driver), then it must also configure Multicast Capability Structures within the fabric to provide for delivery of messages to members of the group. An MCG can be used in both address and ID based multicast since both ID and address based delivery methods are configured identically and by the same registers. Note that greater numbers of MCGs could be used by adding a table per station for ID based MCGs. For example, 256 groups could be supported with a 256 entry table, where each entry is a 24 bit egress port vector.

In one embodiment, a standard MCG—0hFF—was predefined for universal broadcast. VLAN filtering is used to confine a broadcast to members of a VPN. The VLAN filters and MCGs will be configured by the management processor (MCPU) at startup with others defined later via communications between the MCPU and the PLX networking drivers running on attached hosts. The MCPU will also configure and support a Multicast Address Space.

Glossary of Terms

| API | Application Programming Interface |
|---|---|
| BDF | Bus-Device-Function (8 bit bus number, 5 bit device number, 3 bit function |
| | number of a PCI express end point/port in a hierarchy). This is usually |
| | set/assigned on power on by the management CPU/BIOS/OS that enumerates the |
| | hierarchy. In ARI, “D” and “F” are merged to create an 8-bit function number |
| BCM | Byte Count Modified bit in a PCIe completion header. In ExpressFabric ™, BCM |
| | is set only in completions to pull protocol remote read requests |
| BECN | Backwards Explicit Congestion Notification |
| BIOS | Basic Input Output System software that does low level configuration of PCIe |
| | hardware |
| BUS | the bus number of a PCIe or Global ID |
| CSR | Configuration Space Registers |
| CAM | Content Addressable Memory (for fast lookups/indexing of data in hardware) |
| CSR | Used (incorrectly) to refer to Configuration Space or an access to configuration |
| Space | space registers using Configuration Space transfers; |
| DLUT | Destination Lookup Table |
| DLLP | Data Link Layer Packet |
| Domain | A single hierarchy of a set of PCI express switches and end points in that |
| | hierarchy that are enumerated by a single management entity, with unique BDF |
| | numbers |
| Domain | PCI express address space shared by the PCI express end points and NT ports |
| address | within a single domain |
| space | |
| DW | Double word, 32-bit word |
| EEPROM | Electrically erasable and programmable read only memory typically used to store |
| | initial values for device (switch) registers |
| EP | PCI express end point |
| FLR | Function Level Reset for a PCI express end point |
| FUN | A PCIe “function” identified by a Global ID, the lowest 8 bits of which are the |
| | function number or FUN |
| GEP | Global (management) Endpoint of an ExpressFabric ™ switch |
| GID | Global ID of an end point in the advanced Capella 2 PCI ExpressFabric ™. |
| | GID = {Domain, BUS, FUN} |
| Global | Address space common to (or encompassing) all the domains in a multi-domain |
| address | PCI ExpressFabric ™. If the fabric consists of only one domain, then Global and |
| space | Domain address spaces are the same. |
| GRID | Global Requester ID, GID less the Domain ID |
| H2H | Host to Host communication through a PLX PCI ExpressFabric ™ |
| LUT | Lookup Table |
| MCG | A multicast group as defined in the PCIe specification per the Multicast ECN |
| MCPU | Management CPU - the system/embedded CPU that controls/manages the |
| | upstream of a PLX PCI express switch |
| MF | Multi-function PCI express end point |
| MMIO | Memory Mapped I/O, usually programmed input/output transfers by a host CPU |
| | in memory space |
| MPI | Message Passing Interface |
| MR | Multi-Root, as in MR-IOV, as used herein multi-root means multi-host. |
| NT | PLX Non-transparent port of a PLX PCI express switch |
| NTB | PLX Non-transparent bridge |
| OS | Operating System |
| PATH | PATH is a field in DMA descriptors and VDM message headers used to provide |
| | software overrides to the DLUT route look up at enabled fabric stages. |
| PIO | Programmed Input Output |
| P2P, PtoP | Abbreviation for the virtual PCI to PCI bridge representing a PCIe switch port |
| PF | SR-IOV privileged/physical function (function 0 of an SR-IOV adapter) |
| RAM | Random Access Memory |
| RID | Requester ID - the BDF/BF of the requester of a PCI express transaction |
| RO | Abbreviation for Read Only |
| RSS | Receive Side Scaling |
| Rx CQ | Receive Completion Queue |
| SEC | The SECondary BUS of a virtual PCI-PCI bridge or its secondary bus number |
| SEQ | abbreviation for SEQuence number |
| SG list | Scatter/gather list |
| SPP | Short Packet Push |
| SR-PCIM | Single Root PCI Configuration Manager - responsible for configuration and |
| | management of SR-IOV Virtual functions; typically a OS module/software |
| | component built in to an Operating System. |
| SUB | The subordinate bus number of a virtual PCI to PCI bridge. |
| SW | abbreviation for software |
| TC | Traffic Class, a field in PCIe packet headers. Capella 2 host-to-host software |
| | maps the Ethernet priority to a PCIe TC in a one to 1 or many to 1 mapping |
| T-CAM | Ternary CAM, a CAM in which entry includes a mask |
| TSO | TCP Segmentation offload |
| Tx CQ | Transmit Completion Queue |
| Tx Q | Transmit queue, e.g. a transmit descriptor ring |
| TWC | Tunneled Window Connection endpoint that replaces non-transparent bridging to |
| | support host to host PIO operations on an ID-routed fabric |
| TLUT | Tunnel LUT of a TWC endpoint |
| VDM | Vendor Defined Message |
| VEB | Virtual Ethernet Bridge (some backgrounder on one implementation: |
| | http://www.ieee802.org/1/files/public/docs2008/new-dcb-ko-VEB-0708.pdf) |
| VF | SR-IOV virtual function |
| VH | Virtual Hierarchy (the path that contains the connected host's root complex and |
| | the PLX PCI express end point/switch in question) |
| WR | Work Request as in the WR VDMs used in host to host DMA |

### Extension to Other Protocols

While a specific example of a PCIe fabric has been discussed in detail, more generally, the present invention may be extended to apply to any switch fabrics that supports load/store operations and routes packets by means of the memory address to be read or written. Many point-to-point networking protocols include features analogous to the vendor defined messaging of PCIe. Thus, the present invention has potential application for other switch fabrics beyond those using PCIe.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

What is claimed is:

1. A method of operating a multi-path switch fabric having a point-to-point network protocol, the method comprising:
for a packet having a load/store protocol address entering an ingress port of the switch fabric, adding an ID routing prefix to the packet defining a destination ID in a global space of the switch fabric; and
routing the packet to a destination in the switch fabric based on the ID routing prefix.

2. The method of claim 1, wherein the interconnect protocol is PCIe.

3. The method of claim 1 where the ID routing prefix includes a field or fields that increase the size of the destination name space, allowing scalability beyond the limits of standard PCIe.

4. The method of claim 1, further comprising performing a table lookup for a packet entering the switch fabric to determine the destination ID to be used in a routing prefix.

5. The method of claim 4, wherein a lookup is performed in an data structure that includes an entry for each BAR of each endpoint function that has been configured to be accessible by a host connected to the ingress port.

6. The method of claim 4, wherein a lookup is performed at a downstream port in a data structure that includes an entry for each endpoint function that is connected to the downstream port, either directly or via any number of PCIe switches, where the lookup returns the Global ID of the host with which the endpoint function is associated.

7. The method of claim 4, wherein a lookup is done at a downstream port in a data structure that includes an entry for each BAR of each endpoint function elsewhere in the fabric with which a function that is connected to the downstream port, either directly or via any number of PCIe switches is configured to be able to target with a memory space request TLP, where the lookup returns the Global ID of the endpoint function that is targeted.

8. A method of ID routing in a switch fabric, comprising:
performing a look up of destination route choices in a destination lookup table, using the destination ID in an ID routing prefix prepended to the packet or in the packet itself, if the packet doesn't have a prefix.

9. The method of 8 where the lookup is indexed by either Destination Domain or by Destination BUS independently configurable at each ingress port.

10. The method of 9 where lookup using Destination Domain is prohibited if congestion feedback indicates that the route by domain choice would encounter congestion.

11. The method of claim 8, wherein the multi-path switch fabric includes a plurality of routes for the packet to a destination in the switch fabric and a routing choice is based on at least one of whether the packet represents ordered traffic and ordered traffic.

12. The method of claim 9, wherein the routing choice further includes making a routing choice based on congestion feedback.

13. The method of claim 9, further comprising utilizing a round robin determination of the routing choice when no congestion is indicated.

14. The method of claim 9, wherein the interconnect protocol is PCIe.

15. The method of claim 1, further comprising: for the destination of the packet being an external device, removing the routing ID prefix at the destination fabric edge switch port.

16. A method of operating a multi-path PCIe switch fabric, the method comprising:
for a PCIe packet entering the switch fabric, converting the routing from address based routing to ID based routing by performing a table lookup to define an ID routing prefix defining a destination ID and adding the ID routing prefix to the packet, wherein the ID routing prefix defines an ID in a global space of the switch fabric.

17. The method of claim 16, further comprising:
routing the packet to a destination in the multi-path switch based on the ID routing prefix.

18. The method of claim 16, further comprising:
if the packet contains a destination ID and therefore doesn't require an ID routing prefix, routing the packet by that contained destination ID

19. The method of claim 16 where the ID routing prefix includes a field or fields that increase the size of the destination name space, allowing scalability beyond the limits of standard PCIe

20. The method of claim 16, wherein a lookup is performed in an data structure that includes an entry for each BAR of each endpoint function that has been configured to be accessible by a host connected to the ingress port.

21. The method of claim 16, wherein a lookup is performed at a downstream port in a data structure that includes an entry for each endpoint function that is connected to the downstream port, either directly or via any number of PCIe switches, where the lookup returns the Global ID of the host with which the endpoint function is associated.

22. The method of claim 16, wherein a lookup is done at a downstream port in a data structure that includes an entry for each BAR of each endpoint function elsewhere in the fabric with which a function that is connected to the downstream port, either directly or via any number of PCIe switches is configured to be able to target with a memory space request TLP, where the lookup returns the Global ID of the endpoint function that is targeted.

23. The method of claim 16, wherein a look up of destination route choices is made in a destination lookup table, using the destination ID in an ID routing prefix prepended to the packet or in the packet itself, if the packet doesn't have a prefix

24. The method of 16 where the lookup is indexed by either Destination Domain or by Destination BUS independently configurable at each ingress port.

25. The method of 24 where lookup using Destination Domain is prohibited if congestion feedback indicates that the route by domain choice would encounter congestion.

26. The method of claim 16, wherein the multi-path switch fabric includes a plurality of routes for the packet to a destination in the switch fabric and a routing choice is based on at least one of whether the packet represents ordered traffic and ordered traffic.

27. The method of claim 26, wherein the routing choice further includes making a routing choice based on congestion Feedback.

28. The method of claim 26, further comprising utilizing a round robin determination of the routing choice.

29. The method of claim 16, wherein the destination ID is included in a Vendor Defined Message field, allowing such packets to be ID routed without use of an ID routing prefix.

30. The method of claim 16, further comprising: for a destination of the packet being a fabric edge destination switch port, removing the routing ID prefix at the destination edge port.

31. A system comprising:
a switch fabric including at least one PCIe ExpressFabric™ switch and a management system;
wherein a Global ID space is defined for the switch fabric in which each node and device function have a unique Global ID
and wherein packets entering the switch that would be address routed in standard PCIe have an ID routing prefix added to route the packet within the switch fabric by Global ID.

32. The method of claim 1, wherein when the packet that enters the switch is structured for ID routing without change and does not need to be sent into a different Domain, not adding an ID routing prefix and routing the packet by ID using the destination ID information in the unmodified packet.
